(19) United States
(12) Patent Application Publication
(10) Pub. No.: US 2016/0297972 A1
(43) Pub. Date: Oct. 13, 2016

(54) ANTIFOGGING ARTICLE AND MANUFACTURING METHOD THEREOF, BASE LAYER FORMING COMPOSITION, AND ARTICLE FOR TRANSPORTATION APPARATUS

(71) Applicant: ASAHI GLASS COMPANY, LIMITED, Chiyoda-ku (JP)

(72) Inventors: Yusuke Mori, Chiyoda-ku (JP); Hirokazu Kodaira, Chiyoda-ku (JP); Takashige Yoneda, Chiyoda-ku (JP)

(73) Assignee: ASAHI GLASS COMPANY, LIMITED, Chiyoda-ku (JP)

(21) Appl. No.: 15/185,848

(22) Filed: Jun. 17, 2016

Related U.S. Application Data
(63) Continuation of application No. PCT/JP2014/083684, filed on Dec. 19, 2014.

(30) Foreign Application Priority Data
Dec. 25, 2013 (JP) 2013-267879

(51) Int. Cl. C09D 5/00; B05D 3/00; C03C 17/34; C09D 163/00

(52) U.S. Cl. CPC C09D 5/00; C09D 163/00; B05D 3/007; C03C 17/34

(57) ABSTRACT

An antifogging article having an antifogging film excellent in antifogging property and in durability, an article for transportation apparatus provided with the antifogging article, and a base layer forming composition with sufficiently long pot life used for obtaining the antifogging article are provided. An antifogging article has a substrate, and an antifogging film on the substrate having a base layer made of a base material with low water absorbing property, and a water absorbing layer made of a water absorbing material having a water absorbing property higher than that of the base material, and the base material is obtained by using a composition containing (A) a raw material component of a first cured resin, (B) a silane-based coupling agent having a functional group other than an amino group having reactivity with the (A) component and a hydrolyzable group, and (C) tetraalkoxysilane and/or a polymer thereof in a prescribed ratio.

### CROSS-REFERENCE TO RELATED APPLICATIONS

This application is a continuation of prior International Application No. PCT/JP2014/083684, filed on Dec. 19, 2014 which is based upon and claims the benefit of priority from Japanese Patent Application No. 2013-267879, filed on Dec. 25, 2013; the entire contents of all of which are incorporated herein by reference.

### FIELD

The present invention relates to an antifogging article and a manufacturing method thereof, a base layer forming composition used for manufacturing the antifogging article, and an article for transportation apparatus provided with the antifogging article.

### BACKGROUND

In a transparent substrate such as glass or plastic, when a temperature of a substrate surface becomes a dew-point temperature or lower, minute water droplets adhere to the surface and scatter transmitted light, which impairs transparency, and creates what is called “fogging” state. As measures for preventing the fogging, various proposals have been made so far.

Concretely, there are known (1) a method of lowering a surface tension of adhered water droplets by treating the substrate surface with a surfactant, (2) a method of making the substrate surface have a hydrophilic property by giving a hydrophilic group to the substrate surface by using a hydrophilic resin or a hydrophilic inorganic compound, (3) a method of maintaining the temperature of the substrate surface to the dew-point temperature or higher by installing a heater or the like on the substrate and heating the substrate by the heater, (4) a method of providing a water absorbing resin layer on the substrate surface to absorb and remove the minute water droplets formed on the substrate surface, and/or reduce atmospheric humidity on the substrate surface, and the like.

However, in the above-described methods (1) and (2), a water film is formed on the formed film surface, so that when the substrate is retained for a long period in a high-humidity environment, a change in external appearance easily occurs due to occurrence of distortion, formation of water droplets and the like, and a sticky feeling when used is sometimes felt somewhat unpleasant. Further, in the method of (3), the antifogging performance can be sustained semipermanently, but, the energy accompanying supply of electricity is constantly needed, and thus it is very costly. On the other hand, in the method of (4), since no water exists on the surface, it is often the case where no change occurs in external appearance and a sense of use is also favorable, and in addition to that, an excellent antifogging property can be exhibited without requiring running costs, and thus the method is regarded as a particularly excellent method as a measure for preventing fogging.

As such antifogging technology of (4) utilizing the water absorbing resin layer, concretely, there is proposed an antifogging article having an antifogging film in which a low water absorbing cross-linked resin layer and a high water absorbing cross-linked resin layer are stacked in order on a substrate surface (refer to Patent Reference 1 (JP-A No. 2008-273067)). The antifogging film described in Patent Reference 1 is an antifogging film having both of antifogging property and durability. However, in recent years, the antifogging film has been demanded to have higher durability such as, for example, acid resistance and moisture resistance. Because of this, in order to use the antifogging film in applications requiring high durability, a problem sometimes arises in terms of acid resistance in particular with the antifogging film described in Patent Reference 1. Accordingly, an antifogging article having higher acid resistance has been demanded.

### SUMMARY OF THE INVENTION

Here, Patent Reference 1 adopts a method in which a silane-based coupling agent is compounded in a base layer called as the low water absorbing cross-linked resin layer described above for preventing the antifogging film from peeling from the substrate. The peeling resistance in a state where the antifogging film does not absorb water is sufficiently obtained by compounding the silane-based coupling agent, but, there has been a problem in terms of resistance with respect to a phenomenon in which when the antifogging film absorbs water, particularly when the antifogging film absorbs acid water, the water absorbing layer expands too much to be peeled from the substrate, in other words, chemical resistance.

In order to achieve the chemical resistance by preventing such expansion in the base layer of the antifogging film, a method in which a cured resin and a silicon oxide matrix are combined with the base layer to form the base layer, concretely, a method in which a tetrafunctional silane compound having hydrolyzable groups is compounded in a composition for forming the base layer, and the silane compound is subjected to hydrolysis and condensation in conjunction with reaction of a raw material component of the cured resin and the silane-based coupling agent, was considered. However, it was concerned that there arises a problem in terms of productivity such that, when the raw material component of the cured resin and such tetrafunctional silane compound are existed in the same composition, a pot life of the composition is shortened. Therefore, it has been desired to provide an antifogging article having an antifogging film having excellent antifogging property as well as durability of chemical resistance, without causing reduction in productivity.

The present invention has an object to provide an antifogging article having an antifogging film excellent in antifogging property and excellent in durability such as chemical resistance and moisture resistance in particular, and a manufacturing method thereof, and an article for transportation apparatus provided with the antifogging article. The present invention further has an object to provide a base layer forming composition having a sufficiently long pot life for obtaining an antifogging article having an antifogging film excellent in antifogging property and excellent in durability such as chemical resistance and moisture resistance in particular.

The present invention provides an antifogging article and a manufacturing method thereof, a base layer forming composition, and an article for transportation apparatus which have a configuration as follows.
[1] An antifogging article having a substrate and an antifogging film on a surface of at least a part of the substrate, wherein:
   the antifogging film has, in order from the substrate side, a base layer made of a base material with low water absorbing property, and a water absorbing layer made of a water absorbing material having a water absorbing property higher than that of the base material; and
   the base material is obtained by using a base layer forming composition containing the following (A) to (C) components:
   (A) 100 parts by mass of a raw material component of a first cured resin;
   (B) 60 to 200 parts by mass of a silane-based coupling agent having a functional group other than an amino group having reactivity with the (A) component and a hydrolyzable group; and
   (C) 15 to 50 parts by mass, by oxide conversion, of tetraalkoxysilane and/or a polymer thereof
[2] The antifogging article according to [1], wherein a saturated water absorption amount of the water absorbing material is 50 mg/cm³ or more.
[3] The antifogging article according to [1], wherein a saturated water absorption amount of the base material is 10 mg/cm³ or less.
[4] The antifogging article according to [1], wherein the silane-based coupling agent is at least one selected from compounds represented by the following general formula (1),

R¹SiR²ₙX¹₃₋ₙ (1)

In the formula (1), R¹ indicates a monovalent organic group having 1 to 10 carbon atoms and an epoxy group, an acryloxy group, a methacryloxy group, a vinyl group, a mercapto group, an isocyanate group, an ureido group, or a chlorine atom at a terminal thereof, R² indicates a monovalent hydrocarbon group having 1 to 4 carbon atoms, n indicates an integer of 0 or 1, and X¹ indicates hydrolyzable groups which may be mutually the same or different, respectively.
[5] The antifogging article according to [1], wherein the tetraalkoxysilane and/or the polymer thereof is at least one selected from the group consisting of tetramethoxysilane, tetraethoxysilane, methyl silicate having average degree of polymerization is 2 to 10, and ethyl silicate having average degree of polymerization is 2 to 10.
[6] The antifogging article according to [1], wherein the first cured resin is a first cured epoxy resin, a first polyurethane resin, or a first cross-linked acrylic resin.
[7] The antifogging article according to [1], wherein the first cured resin is a cured epoxy resin, the (A) component contains a first polyepoxide component, and a first polyaddition type curing agent and/or a first catalyst type curing agent, and the functional group contained in the (B) component is an epoxy group and/or a group having reactivity with the epoxy group.
[8] The antifogging article according to [7], wherein the first catalyst type curing agent contains an imidazole compound, and the first polyaddition type curing agent contains an acid anhydride.
[9] The antifogging article according to [1], wherein the water absorbing material is obtained by using a water absorbing layer forming composition containing a raw material component of a second cured resin selected from a second cured epoxy resin, a second polyurethane resin, and a second cross-linked acrylic resin.
[10] The antifogging article according to [9], wherein the raw material component of the second cured epoxy resin contain a second polyepoxide component, a second polyaddition type curing agent, and a second catalyst type curing agent.
[11] The antifogging article according to [1], wherein a film thickness of the base layer is 1 to 8 μm, and a film thickness of the water absorbing layer is 5 to 30 μm.
[12] The antifogging article according to [1], wherein the substrate is made of glass.
[13] An article for transportation apparatus, including the antifogging article according to [1].
[14] A base layer forming composition for obtaining the antifogging article according to [1], the base layer forming composition containing: the (A) to (C) components; and a (D) solvent.
[15] A manufacturing method of the antifogging article according to [1], the method including:
   applying and curing the base layer forming composition on a substrate surface to form the base layer; and
   forming the water absorbing layer made of the water absorbing material on a surface of the base layer.

According to the present invention, it is possible to provide an antifogging article having an antifogging film excellent in antifogging property and excellent in durability such as chemical resistance and moisture resistance in particular, and a manufacturing method thereof, and an article for transportation apparatus provided with the antifogging article. According to the present invention, it is possible to provide a base layer forming composition having a sufficiently long pot life for obtaining an antifogging article having an antifogging film excellent in antifogging property and excellent in durability such as chemical resistance and moisture resistance in particular.

### DETAILED DESCRIPTION

Hereinafter, embodiments of the present invention will be described. Note that the present invention should not be construed as limited to the following description.

### <Antifogging Article>

An antifogging article of the present invention is an antifogging article having a substrate, and an antifogging film disposed on a surface of at least a part of the substrate, in which the antifogging film has, in order from the substrate side, a base layer made of a base material with low water absorbing property, and a water absorbing layer made of a water absorbing material having a water absorbing property higher than that of the base material, and the base material is obtained by using a base layer forming composition containing the following (A) to (C) components:
(A) 100 parts by mass of a raw material component of a first cured resin;
(B) 60 to 200 parts by mass of a silane-based coupling agent having a functional group, with the exception of an amino group, having reactivity with respect to the (A) component and a hydrolyzable group; and
(C) 15 to 50 parts by mass, by oxide conversion, of tetraalkoxysilane and/or a polymer thereof.

Here, the cured resin in the present specification indicates a cured product obtained when a curable raw material component is cured. The raw material component of the cured resin contains at least a curable component, and preferably further contains a curing agent. Normally, as the curing agent, a polyaddition type curing agent, a condensation type curing agent, a catalyst type curing agent, or the like is used, although depending on the kind of cured resin. Further, when the raw material component of the cured resin is cured, a cross-linking reaction between the raw material component occurs, resulting in that the obtained cured resin has a three-dimensional network structure.

In the antifogging article provided with the antifogging film having the base layer and the water absorbing layer which are stacked in order on the substrate, since the water absorbing material constituting the water absorbing layer has the water absorbing property higher than that of the base material constituting the base layer, the excellent antifogging property is provided, and since the water absorbing property of the base material constituting the base layer is relatively low, adhesiveness between the base layer and the substrate can be secured. Concretely, the water absorbing layer is preferably constituted of the water absorbing material whose saturated water absorption amount is 50 mg/cm³ or more, and the base layer is preferably constituted of the base material whose saturated water absorption amount is 10 mg/cm³ or less. Note that the water absorbing property of the water absorbing layer and the base layer can be evaluated by setting not only the saturated water absorption amounts of the composing materials of the respective layers but also a later-described water absorbing and antifogging property as an index.

Further, by obtaining the base material constituting the base layer by using the base layer forming composition containing the above-described (A) to (C) components, namely, by forming the base layer by using the base layer forming composition, the base layer becomes a layer having good moisture resistance as well as good chemical resistance in which the expansion caused by acid water is suppressed, and thus the base layer enhances the durability as the antifogging film. Hereinafter, tetraalkoxysilane and/or a polymer thereof is sometimes referred to as “tetraalkoxysilane and the like”.

When the base layer is formed by using the base layer forming composition, a three-dimensional network structure of the first cured resin is formed through a cross-linking reaction of the raw material component of the first cured resin, and at the same time, a silicon oxide matrix is formed through a hydrolysis and condensation reaction of the tetraalkoxysilane and the like. At this time, the functional group contained in the silane-based coupling agent and the reactive group contained in the raw material component of the cured resin are bonded, and at the same time, the hydrolyzable group contained in the silane-based coupling agent and alkoxy groups contained in the tetraalkoxysilane and the like are subjected to the hydrolysis and condensation reaction to be bonded. It can be considered that, through these reactions, the obtained base material has a structure which is resistant to the expansion as a whole.

Note that in the base layer forming composition for forming the base layer, by employing the above configuration for improving the properties of the obtained base layer, reduction in pot life which is disadvantageous in terms of production is not recognized, and thus no influence is exerted on the productivity of the antifogging article. Formerly, if a certain amount or more of tetraalkoxysilane and the like exists in a base layer forming composition containing a curable component and a curing agent being the raw material component of a cured resin to be described later, a silane-based coupling agent, and the tetraalkoxysilane and the like, the raw material component of the cured resin and the silane-based coupling agent act to facilitate gelation of the tetraalkoxysilane and the like, and accordingly, compounding of the certain amount or more of the tetraalkoxysilane and the like sometimes causes a problem in the pot life. Further, the gelation is facilitated particularly when a component having amine active hydrogen exists in the base layer forming composition.

In the present invention, the silane-based coupling agent to be existed in the base layer forming composition is compounded in an amount equal to or greater than an amount required for the improvement of adhesiveness and the like, so that it is functioned as a coupling agent for the silicon oxide matrix formed of the tetraalkoxysilane and the like and the cured resin, and by employing the silane-based coupling agent to be used containing no amine active hydrogen which is regarded as a cause of facilitation of gelation, the properties of the obtained base layer can be improved, and besides, the composition causing no reduction in pot life is realized. Hereinafter, elements constituting the antifogging article will be described in order.

[1] Substrate

The substrate used for the antifogging article of the present invention is not particularly limited as long as it is a substrate made of a material for which addition of an antifogging property is generally desired. Preferably, there can be cited a substrate made of glass, plastic, metal, ceramics, or a combination of these (composite material, stacked material, or the like). More preferably, there can be cited a transparent substrate made of glass or plastic, and a mirror and the like. As the glass, ordinary soda lime glass, borosilicate glass, non-alkali glass, quartz glass, or the like can be cited, and among them, the soda lime glass is particularly preferable. Further, as the plastic, an acryl-based resin such as polymethyl methacrylate, an aromatic polycarbonate-based resin such as polyphenylene carbonate, and an aromatic polyester-based resin such as polyethylene terephthalate (PET) can be cited, and among them, the polyethylene terephthalate (PET), the polyphenylene carbonate, and the like is preferable. Among the above-described various substrates, in the present invention, a substrate made of the glass is preferable, and a substrate made of the soda lime glass is particularly preferable.

A shape of the substrate is not particularly limited. As the shape of the substrate, there can be cited a plate shape, for example. As the plate shape, a flat plate shape may be employed, or a shape in which the entire surface or a part thereof has a curvature may also be employed. When the substrate has the plate shape, a thickness of the substrate is preferably 1 to 10 mm in general, although it can be selected appropriately depending on the application of the antifogging article.

Further, the substrate preferably has a reactive group on a surface thereof. As the reactive group, a hydrophilic group is preferable, and as the hydrophilic group, a hydroxyl group is preferable. Further, it is also possible to make the substrate surface have a hydrophilic property, by performing oxygen plasma treatment, corona discharge treatment, ozone treatment, or the like on the substrate to decompose and remove organic matters adhered to the surface, or by forming a minute convexoconcave structure on the surface. Note that glass or metal oxide normally has a hydroxyl group on its surface.

Further, for the purpose of increasing adhesiveness between the substrate and a base layer formed on the surface of the antifogging article of the present invention, the substrate may also be one in which a metal oxide thin film of silica, alumina, titania, zirconia, or the like or a thin film made of metal oxide containing organic group is provided on the surface of the substrate of glass or the like.

The metal oxide thin film can be formed through a publicly-known method such as sol-gel method by using a metal compound having a hydrolyzable group. As the metal compound, tetraalkoxysilane, tetraisocyanatesilane, or an oligomer thereof (that is, partially hydrolyzed condensate thereof) or the like is preferable.

Further, the thin film made of metal oxide containing organic group can be obtained by treating the substrate surface with an organic metal-based coupling agent. As the organic metal-based coupling agent, it is possible to use a silane-based coupling agent, a titanium-based coupling agent, an aluminum-based coupling agent, or the like, and it is preferable to use the silane-based coupling agent.

[2] Antifogging Film

In the antifogging article of the present invention, the antifogging film formed on the surface of at least a part of the substrate is configured by the base layer and the water absorbing layer formed in this order from the substrate side.

[2-1] Base Layer

The base layer included in the antifogging film is a layer made of the base material with low water absorbing property and formed on the substrate and on the substrate side of the later-described water absorbing layer, namely, between the substrate and the water absorbing layer. Here, when the water absorbing property is low, this means that the water absorbing property is lower than that of the water absorbing material constituting the water absorbing layer.

The saturated water absorption amount of the base material constituting the base layer is preferably 10 mg/cm³ or less, more preferably 8 mg/cm³ or less, and particularly preferably 7 mg/cm³ or less. Note that concretely, the saturated water absorption amount is a physical property value of measuring a water absorbing performance of the material measured by the following method. As described above, from a viewpoint of preventing the antifogging film from peeling from the substrate by reducing a difference in degree of expansion and contraction in the adhesive interface between the substrate and the antifogging film, actually the substrate and the base layer, it is preferable to set the saturated water absorption amount of the base material constituting the base layer to the above-described value. On the other hand, from a viewpoint of reducing a difference in degree of expansion and contraction between the base layer and the water absorbing layer in the antifogging film, the saturated water absorption amount of the base material constituting the base layer is preferably 1 mg/cm³ or more, and more preferably 3 mg/cm³ or more.

(Measuring Method of Saturated Water Absorption Amount)

A layer of material to be an analyte (hereinafter, referred to as “material layer”) is provided on a soda lime glass substrate of 3 cm×4 cm×2 mm thickness, which is left for two hours in a thermohygrostat under an environment of 10° C. and 95 to 99% RH, and after it is taken out, an amount of moisture (I) of the entire substrate with the material layer is measured by using a micro moisture meter. Further, an amount of moisture (II) regarding only the substrate is measured through a similar procedure. A value obtained by dividing a value as a result of subtracting the amount of moisture (II) from the amount of moisture (I) by the volume of the material layer, is taken as the saturated water absorption amount. Note that the measurement of the amount of moisture is performed as follows by using a micro moisture meter FM-300 (product name, manufactured by Kett Electric Laboratory). A measurement sample is heated at 120° C., moisture emitted from the sample is absorbed by molecular sieves in the micro moisture meter, and a change in mass of the molecular sieves is measured as the amount of moisture. Further, an end point of the measurement is set to a point where the change in mass per 25 seconds becomes less than 0.05 mg or less.

Note that, although the saturated water absorption amount is an index indicating the water absorbing property of the base material constituting the base layer, the “water absorbing and antifogging property” defined below is used according to need in the present specification as an index indicating the water absorbing property of the base layer itself owing to the base material constituting the base layer and the thickness of the layer. The water absorbing and antifogging property is indicated by an antifogging time (second) until when fogging is visually recognized when the substrate with the material layer prepared in a manner similar to the above is left for one hour under an environment of 20° C. and 50% RH, and the surface of the material layer is held above a hot water bath of 35° C.

When the water absorbing and antifogging property is indicated as an index as for the water absorbing property of the base layer provided to the antifogging article of the present invention, the water absorbing and antifogging property of the base layer is preferably 10 seconds or less, more preferably 7 seconds or less, and particularly preferably 3 seconds or less. Note that in a similar manner to the saturated water absorption amount, from a viewpoint of reducing the difference in degree of expansion and contraction between the base layer and the water absorbing layer in the antifogging film, the water absorbing and antifogging property of the base layer is preferably 1 second or more, and more preferably 2 seconds or more.

Based on a relation between the saturated water absorption amount of the base material constituting the base layer and the water absorbing and antifogging property of the base layer, a film thickness of the base layer related to the antifogging article of the present invention is preferably 1 μm or more, and more preferably 1.5 μm or more. When the film thickness of the base layer is 1 μm or more, it becomes possible to prevent the peeling of the antifogging film from the substrate, resulting in that the antifogging article excellent in the acid resistance and the moisture resistance can be obtained. Further, because of the reason of alleviating stress occurring in the interface due to expansion and contraction of the water absorbing layer, the film thickness of the base layer is more preferably 1.5 μm or more. Further, the film thickness of the base layer is preferably 8 μm or less, and more preferably 6 μm or less, from a viewpoint of reducing material costs and improving non-defective ratio. Here, the peeling resistance required for the base layer in the antifogging article differs depending on application, so that the design of the base layer may be changed appropriately in line with required performance.

The base material constituting the base layer is obtained from the base layer forming composition containing the following (A) to (C) components. In other words, the base layer is formed by using the base layer forming composition.
(A) 100 parts by mass of a raw material component of a first cured resin.
(B) 60 to 200 parts by mass of a silane-based coupling agent having a functional group, with the exception of an amino group, having reactivity with respect to the (A) component and a hydrolyzable group (which is sometimes simply referred to as “(B) silane-based coupling agent”, hereinafter).
(C) 15 to 50 parts by mass, by oxide conversion, of tetraalkoxysilane and/or a polymer thereof (which is sometimes referred to as “(C) tetraalkoxysilane and the like”, hereinafter).

When the base layer forming composition contains the (A) to (C) components, the obtained base material has a structure which is resistant to the expansion as a whole, which can contribute to the chemical resistance and the moisture resistance of the antifogging film. Further, the adhesiveness of the antifogging film with respect to the substrate is also improved, resulting in that the durability as the entire antifogging film is enhanced.

Further, in the base layer forming composition for forming the base layer, by employing the above-described configuration for improving the properties of the obtained base layer, reduction in pot life which is disadvantageous in terms of production is not recognized, and thus no influence is exerted on the productivity of the antifogging article.

Note that the base layer forming composition may also contain a solid component other than the above-described (A) to (C) components, within a range that does not impair the effects of the present invention. The solid component indicates a component which becomes a base material itself, out of components contained in the base layer forming composition, namely, a component which forms the base layer, and a component which is remained after removing a volatile component such as a solvent.

As described above, when obtaining the base material by using such a base layer forming composition, the following three reactions are performed concurrently.
(i) A three-dimensional network structure of the first cured resin is formed through a cross-linking reaction of the (A) component.
(ii) A silicon oxide matrix is formed through a hydrolysis and condensation reaction of the (C) component.
(iii) The (B) component bonds with the first cured resin at one terminal thereof, and bonds with the silicon oxide matrix at the other terminal thereof.
   Therefore, it can be said that the base material obtained through the reactions of (i) to (iii) of the (A) to (C) components is a material having a three-dimensional network structure in which the (A) to (C) components are bonded with one another.

Note that when the base layer forming composition further contains another reactive component, it is possible to obtain, as a base material, a material having a three-dimensional network structure in which the (A) to (C) components and the reactive component bond with one another. Further, when a non-reactive component is contained, it is possible to obtain a material in which the non-reactive component is taken into the three-dimensional network structure formed by the (A) to (C) components which are bonded one another.

(A) Raw Material Component of First Cured Resin

The base layer forming composition contains the raw material component of the first cured resin. As the first cured resin, there can be cited a first cured epoxy resin, a first polyurethane resin, a first cross-linked acrylic resin, or the like. Note that when a curable component and a curing agent related to the first cured resin are mentioned in the description hereinbelow, all of them will be referred to as “first . . . ”.

The first cured epoxy resin is obtained through reaction of a composition containing a first polyepoxide component and a first curing agent, for example. The first polyurethane resin is obtained through reaction of a composition containing first polyisocyanate and first polyol, for example. The first cross-linked acrylic resin is obtained through reaction of a composition containing a first cross-linkable (meth)acrylic polymer and a first acrylic resin curing agent, for example.

In the present specification, polyepoxide indicates a compound in which two or more epoxy groups exist in one molecule. The polyepoxide includes a low molecular compound, an oligomer, and a polymer. The polyepoxide component is a curable component constituted of at least one kind of polyepoxide.

Further, the curing agent of the cured epoxy resin is used as a term which includes a compound in which two or more reactive groups which react with the epoxy groups contained in the polyepoxide exist in one molecule, being a polyaddition type curing agent, a type that undergoes polyaddition with polyepoxide by reaction, or a condensation type curing agent of a type that undergoes polycondensation with polyepoxide by reaction, and a catalyst type curing agent which is a reaction catalyst such as Lewis acid, and catalyzes a polymerization reaction of mutual polyepoxides. Note that although there are a thermosetting type and a light-curing type as the catalyst type curing agent, they are collectively referred to as the catalyst type curing agent.

The cured epoxy resin has a structure in which the polyepoxides are cross-linked by the polyaddition type curing agent and the like, to be three dimensional, and/or a structure in which the polyepoxides are three-dimensionally polymerized with each other.

In the present specification, polyisocyanate indicates a compound in which two or more isocyanate groups exist in one molecule. The polyisocyanate includes a low molecular compound, an oligomer, and a polymer. Further, polyol indicates a high molecular compound whose molecular weight is approximately 200 or more, in which two or more active hydrogen groups such as alcoholic hydroxyl groups exist in one molecule. The polyurethane resin indicates a cured product obtained when the polyisocyanate and the polyol are subjected to a cross-linking reaction. Normally, in the polyurethane resin, the polyol is set to a curable component, and the polyisocyanate is set to a curing agent. The polyurethane resin has a structure in which the polyols are cross-linked by the polyisocyanates, to be three dimensional.

In the present specification, the cross-linkable (meth)acrylic polymer is a (co)polymer obtained when (co)polymerizing a (meth)acrylic acid compound selected from acrylic acid, methacrylic acid, esters thereof, and the like, and a compound in which two or more cross-linkable groups exist in one molecule. Note that the cross-linkable (meth)acrylic polymer may contain a polymer unit derived from a monomer except for the (meth)acrylic acid compound of less than 10 mol % with respect to the total polymer units. The acrylic resin curing agent indicates a compound in which two or more functional groups having reactivity with respect to the cross-linkable groups contained in the cross-linkable (meth)acrylic polymer exist in one molecule. The cross-linked acrylic resin indicates a cured product obtained when the cross-linkable (meth)acrylic polymer and the acrylic resin curing agent are subjected to a cross-linking reaction. Here, the “polymer unit” indicates a minimum recurring unit formed by a polymerization reaction of a monomer being a compound having polymerizable reactive groups.

The cross-linked acrylic resin has a structure in which the cross-linkable (meth)acrylic polymers are cross-linked by the acrylic resin curing agent, to be three dimensional. The “(meth)acrylic . . . ” in the present specification is a generic term of “methacrylic . . . ” and “acrylic . . . ”. The same applies to “(meth)acryloxy . . . ”.

In the present invention, it is preferable that the kind of the first cured resin is selected to be a kind same as that of the second cured resin used for producing the water absorbing material constituting the water absorbing layer to be described later, from a viewpoint of adhesiveness between layers of the water absorbing layer and the base layer. Hereinafter, description will be made regarding the respective cured resins by setting that the kind of the second cured resin used for producing the water absorbing material constituting the water absorbing layer to the kind same as that of the first cured resin. However, it is also possible to employ a combination of the cured resins in which the kind of the second cured resin and the kind of the first cured resin are different, according to need.

(First Cured Epoxy Resin)

As the raw material component of the first cured epoxy resin, it is preferable to employ a combination of the first polyepoxide component being the first curable component and the first curing agent. As the first curing agent, it is preferable to use a first catalyst type curing agent and/or a first polyaddition type curing agent. Specifically, the first cured epoxy resin is preferably a resin having a structure in which the polyepoxides and the polyaddition type curing agent are three-dimensionally polymerized, or the polyepoxides are three-dimensionally polymerized with each other, obtained through reaction between the first polyepoxide component, and the first catalyst type curing agent or the first polyaddition type curing agent or both of the curing agents.

<First Polyepoxide Component>

As the first polyepoxide component used for the first cured epoxy resin, it is possible to use polyepoxide appropriately selected from glycidyl ether-based polyepoxide, glycidyl ester-based polyepoxide, glycidyl amine-based polyepoxide, a cycloaliphatic polyepoxide, and the like, which are normally used as a raw material component of a cured epoxy resin, so that the water absorbing property of the obtained base material falls within the above-described preferable range.

Although a molecular weight of the polyepoxide used as the first polyepoxide component is not particularly limited, from viewpoints of avoiding insufficient wet spreading when the polyepoxide is applied on the substrate as the base layer forming composition and external appearance defect such as unevenness of a coating film, polyepoxide with a molecular weight of about 200 to 2000 is preferable. Further, although the number of epoxy groups per molecule of the polyepoxide in the first polyepoxide component is not particularly limited as long as it is two or more on average, it is preferably 2 to 10, more preferably 2 to 8, and still more preferably 2 to 6.

Note that in the present specification, the molecular weight refers to a mass average molecular weight (Mw) unless otherwise specified. Further, the mass average molecular weight (Mw) in the present specification refers to a mass average molecular weight measured by gel permeation chromatography (GPC) with polystyrene being a standard.

Although the first polyepoxide component may be any one of aliphatic polyepoxide, alicyclic polyepoxide, and aromatic polyepoxide, for example, by selecting the aromatic polyepoxide, the three-dimensional network structure of the obtained base material can be made hard, and the water absorbing property can be lowered by making a space thereof small. It is conceivable that, even in the aliphatic or alicyclic (referred to as “aliphatic/alicyclic”, hereinafter) polyepoxide, when the number of cross-linking points (branch points of the three-dimensional network structure) is increased, the obtained base material has a dense three-dimensional network structure, the space for retaining water becomes small, and thus the water absorbing property decreases.

As the aliphatic/alicyclic polyepoxide used for the first polyepoxide component, concretely, there can be cited aliphatic/alicyclic glycidyl ester-based polyepoxide and aliphatic/alicyclic glycidyl ether-based polyepoxide derived from aliphatic/alicyclic polyols, and the like. The aliphatic/alicyclic glycidyl ether-based polyepoxide derived from aliphatic/alicyclic polyols is preferable.

As the aliphatic/alicyclic glycidyl ether-based polyepoxide which is preferably used in the present invention, concretely, there can be cited glycerol polyglycidyl ether, polyglycerol polyglycidyl ether, sorbitol polyglycidyl ether, polyethylene glycol polyglycidyl ether, polyethylene glycol sorbitol polyglycidyl ether, and polysorbitol polyglycidyl ether.

The alicyclic polyepoxide is polyepoxide having an alicyclic hydrocarbon group (2,3-epoxycyclohexyl group, or the like) in which an oxygen atom bonds between adjacent carbon atoms of the ring, and concretely, 3,4-epoxycyclohexyl methyl-3′,4′-epoxycyclohexane carboxylate, bis(3,4-epoxycyclohexyl methyl) adipate, and the like can be cited.

As the aromatic polyepoxide used as the first polyepoxide component, preferably, there can be cited polyepoxide having a structure in which a phenolic hydroxyl group is substituted by a glycidyl oxy group. Concretely, there can be cited bisphenol diglycidyl ethers such as bisphenol-A diglycidyl ether, bisphenol-F diglycidyl ether, and bis(4-glycidyl oxyphenyl); phenol-novolac diglycidyl ethers; cresol-novolac diglycidyl ethers; aromatic polycarboxylic acid polyglycidyl esters such as phthalic acid diglycidyl ester; and the like. Among these aromatic polyepoxides, the bisphenol-A diglycidyl ether or the bisphenol-F diglycidyl ether is preferably used as the first polyepoxide component.

In order to increase the number of cross-linking points of the obtained base material to control the water absorbing property to be low in the first polyepoxide component, for example, when the first polyepoxide component is the aliphatic glycidyl ether-based polyepoxide derived from aliphatic polyols, the epoxy equivalent (the number of grams of a resin containing epoxy groups equivalent to one gram [g/eq], and the unit will be omitted below) thereof is preferably 100 to 250, and more preferably 150 to 200. The first polyepoxide component may be constituted of one kind of these polyepoxides or two kinds or more thereof.

Note that as the polyepoxide which can constitute the first polyepoxide component, it is possible to use commercial products. As such commercial products, concretely, there can be cited Denacol EX-313 (molecular weight (Mw): 383, epoxy equivalent: 141), and Denacol EX-314 (molecular weight (Mw): 454, epoxy equivalent: 144), being glycerol polyglycidyl ether, and Denacol EX-512 (molecular weight (Mw): 630, epoxy equivalent: 168) being polyglycerol polyglycidyl ether, and the like, all of which are product names and manufactured by Nagase ChemteX Corporation.

Further, there can be cited Denacol EX-1410 (molecular weight (Mw): 988, epoxy equivalent: 160), Denacol EX-1610 (molecular weight (Mw): 1130, epoxy equivalent: 165), and Denacol EX-610U (molecular weight (Mw): 1408, epoxy equivalent: 210) being aliphatic polyglycidyl ether, Denacol EX-521 (molecular weight (Mw): 1294, epoxy equivalent: 179) being polyglycerol polyglycidyl ether, Denacol EX-614B (molecular weight (Mw): 949, epoxy equivalent: 171) being sorbitol polyglycidyl ether, and the like.

As commercial products of the aromatic polyepoxide, concretely, there can be cited jER828 (product name, manufactured by Mitsubishi Chemical Corporation, molecular weight (Mw): 340, epoxy equivalent: 190) as bisphenol-A diglycidyl ether, ADEKA RESIN EP4901 (product name, manufactured by ADEKA CORPORATION) as bisphenol-F diglycidyl ether, and the like.

<First Catalyst Type Curing Agent>

As the first catalyst type curing agent which is used together with the first polyepoxide component, a catalyst type curing agent can be used without any particular limitation as long as it is a reaction catalyst such as Lewis acid and catalyzes polymerization reaction of mutual polyepoxides.

By using the first catalyst type curing agent, an effect of accelerating the speed of cross-linking by the polymerization reaction of the mutual first polyepoxide components and an effect of reducing a defect occurring in a cross-linking portion can be obtained. As one example of the defect of the cross-linking portion, there can be cited coloring of a cured epoxy resin due to deterioration of cross-linking portion by a heat load.

As the first catalyst type curing agent, concretely, there can be cited curing catalysts such as a tertiary amine compound, an imidazole compound, Lewis acids, onium salts, and phosphines. More concretely, there can be cited 2-methylimidazole, 2-ethyl-4-methylimidazole, tris(dimethylaminomethyl) phenol, a boron trifluoride-amine complex, methyl p-toluenesulfonate, diphenyl iodonium hexafluorophosphate, triphenyl sulfonium hexafluorophosphate, and the like. As the first catalyst type curing agent, one kind of them may be used independently, or two kinds or more of them may be used in combination.

Note that the onium salts such as diphenyl iodonium hexafluorophosphate and triphenyl sulfonium hexafluorophosphate exemplified above are catalyst type curing agents which decompose due to light of ultraviolet rays or the like to generate a Lewis acid catalyst, and normally used as a catalyst type curing agent giving a cured epoxy resin of light-curing type.

Out of the above, as the first catalyst type curing agent used in the present invention, imidazole compounds such as 2-methylimidazole and 2-ethyl-4-methylimidazole are preferable.

It is also possible to use a commercial product for the first catalyst type curing agent. As such a commercial product, there can be cited, for example, Adekaoptomer SP-152 (product name, manufactured by ADEKA CORPORATION) or the like as a triarylsulfonium salt which is a catalyst type curing agent of light-curing type.

The use amount of the first catalyst type curing agent is preferably 1.0 to 20 mass %, more preferably 1 to 10 mass %, and particularly preferably 1 to 5 mass % with respect to 100 mass % of the first polyepoxide component. When the use amount of the first catalyst type curing agent with respect to 100 mass % of the first polyepoxide component is set to 1.0 mass % or more, the reaction proceeds sufficiently, and sufficient durability such as moisture resistance and chemical resistance can be realized in the obtained base material. Further, when the use amount of the first catalyst type curing agent with respect to 100 mass % of the first polyepoxide component is 20 mass % or less, it is possible to easily suppress occurrence of problem in external appearance such that residues of the first catalyst type curing agent exist in the obtained first cured epoxy resin so that color of the cured epoxy resin changes to yellow.

<First Polyaddition Type Curing Agent>

The first polyaddition type curing agent is not particularly limited as long as it is a compound having reactive groups which react with the epoxy groups contained in the polyepoxide constituting the first polyepoxide component, and a curing agent of a type that undergoes polyaddition with polyepoxide by reaction.

As the reactive groups which react with the epoxy groups in the first polyaddition type curing agent, there can be cited phenol groups having active hydrogen, an acid anhydride, and the like. In the present invention, the acid anhydride is preferably used as the compound having the reactive groups as above. As the first polyaddition type curing agent, one kind of them may be used independently, or two kinds or more of them may be used in combination.

As the acid anhydride, there can be cited, for example, a succinic anhydride, a methyltetrahydrophthalic anhydride, a hexahydrophthalic anhydride, a 4-methylhexahydrophthalic anhydride, and the like.

It is also possible to use a commercial product for the first polyaddition type curing agent. As such a commercial product, concretely, there can be cited HN-2200 (product name, manufactured by Hitachi Chemical Company, Ltd.) and the like as the methyltetrahydrophthalic anhydride. Note that although there are isomers in the methyltetrahydrophthalic anhydride, there is no difference regarding actions as the polyaddition type curing agent between the isomers. Therefore, regarding the use of the methyltetrahydrophthalic anhydride, it is also possible to use the isomer mixture.

Regarding the content ratio of the first polyepoxide component and the first polyaddition type curing agent in the raw material component of the first cured epoxy resin, the equivalent ratio of the reactive groups of the first polyaddition type curing agent with respect to the epoxy groups derived from the first polyepoxide component is preferably a ratio of 0.01 to 1.2, and more preferably 0.01 to 1.0.

When the first polyepoxide component and the first polyaddition type curing agent are used in combination at the time of obtaining the first cured epoxy resin used in the present invention, it is preferable to use the first catalyst type curing agent in addition to the first polyepoxide component and the first polyaddition type curing agent. When the first polyaddition type curing agent and the first catalyst type curing agent are used in combination, the first polyaddition type curing agent preferably contains an acid anhydride, and the first catalyst type curing agent preferably contains an imidazole compound. This is because, by using the first catalyst type curing agent, it is possible to achieve an effect of accelerating the speed of cross-linking by the polyaddition reaction between the first polyepoxide component and the first polyaddition type curing agent.

The first curing agent in the raw material component of the first cured epoxy resin is preferably formed of the first catalyst type curing agent or the first polyaddition type curing agent, or both of the curing agents. However, it is preferable that an amine-based polyaddition type curing agent such as polyamine is not contained, since it facilitates gelation of the (C) tetraalkoxysilane and the like.

It is also possible that the raw material component of the first cured epoxy resin contain a compound having one amine active hydrogen in a molecule, such as the imidazole compound used as the first catalyst type curing agent, for example. However, when the first catalyst type curing agent contains a compound containing amine active hydrogen, it is preferable that the amine active hydrogen is previously reacted with the epoxy group to be turned into tertiary amine, from a viewpoint of suppressing the gelation of the (C) tetraalkoxysilane and the like.

The above is the description regarding the case where the first cured epoxy resin is used as the first cured resin. Regarding the first cured resin other than the first cured epoxy resin such as, for example, the first polyurethane resin and the first cross-linked acrylic resin, it is also possible to cite, as raw material component thereof, a combination of a curable component and a curing agent in the conventionally publicly-known cured resin used as a base layer of a water absorbing layer in an antifogging film.

A content of the (A) raw material component of the first cured resin in the base layer forming composition is preferably 20 to 50 mass %, and more preferably 24 to 48 mass % with respect to the total solid content. By setting the range of the content to the above-described range, a film with excellent chemical resistance and moisture resistance is provided.

(B) Silane-Based Coupling Agent

The base layer forming composition contains the (B) silane-based coupling agent by a ratio of 60 to 200 parts by mass with respect to 100 parts by mass of the (A) component. In the base layer forming composition, by setting the range of the content of the (B) silane-based coupling agent to the aforementioned range, while satisfying the other requirements, the obtained base material has a structure resistant to the expansion as a whole, and it becomes possible to form a base layer having good moisture resistance and chemical resistance, and having a moderate water absorbing property as described above.

The (B) silane-based coupling agent is a silane compound having a functional group, with the exception of an amino group, having reactivity with respect to the (A) component and hydrolyzable groups. The functional group possessed by the (B) silane-based coupling agent depends on the kind of the raw material component of the first cured resin of (A). When the first cured resin is the first cured epoxy resin, and the combination of the first polyepoxide component and the first catalyst type curing agent and/or the first polyaddition type curing agent is employed as the raw material component, the functional group, with the exception of the amino group, having the reactivity with respect to the (A) component is preferably a group having reactivity with respect to the first polyepoxide component, concretely, an epoxy group and/or a group having reactivity with respect to the epoxy group.

Further, when the first cured resin is the first polyurethane resin, reactive groups possessed by the raw material component of the resin are active hydrogen groups such as alcoholic hydroxyl groups and isocyanate groups, and the functional group possessed by the (B) silane-based coupling agent is a group having reactivity with respect to the active hydrogen groups and/or the isocyanate groups. When the first cross-linked acrylic resin is employed, reactive groups possessed by the raw material component of the resin are cross-linkable groups possessed by the cross-linkable (meth)acrylic polymer, and functional groups having reactivity with respect to the aforementioned cross-linkable groups possessed by the acrylic resin curing agent, and the functional group possessed by the (B) silane-based coupling agent is a group having reactivity with respect to the cross-linkable groups and/or the functional groups.

Note that the functional group having the reactivity with respect to the (A) component possessed by the (B) silane-based coupling agent includes the reactive group itself possessed by the (A) component. This is because, when the cured epoxy resin is obtained through the polymerization reaction of mutual polyepoxides in the first cured epoxy resin, for example, the epoxy group reacts with the epoxy group.

As the (B) silane-based coupling agent, concretely, there can be cited at least one selected from compounds represented by the following general formula (1). Hereinafter, the compound represented by the formula (1) is sometimes referred to as a compound (1).

R¹SiR²ₙX¹₃₋ₙ (1)

In the formula (1), R¹ indicates a monovalent organic group having 1 to 10 carbon atoms and an epoxy group, a (meth)acryloxy group, a vinyl group, a mercapto group, an isocyanate group, an ureido group, or a chlorine atom at a terminal thereof, R² indicates a monovalent hydrocarbon group having 1 to 4 carbon atoms, n indicates an integer of 0 or 1, and X¹ indicates hydrolyzable groups which may be mutually the same or different, respectively. In the formula (1), R² is more preferably a methyl group or an ethyl group, and is particularly preferably the methyl group.

X¹ is the hydrolyzable group, and as concrete examples thereof, there can be cited a chlorine atom, and an alkoxy group having 1 to 4 carbon atoms. Out of the above, the alkoxy group having 1 to 4 carbon atoms is preferable, and a methoxy group or an ethoxy group is particularly preferable. The number of hydrolyzable groups bonded to a silicon atom is two or three, and the two or three hydrolyzable groups may be the same of different.

In the formula (1), the number of carbon atoms of R¹ is a number of carbon atoms including a number of carbon atoms of terminal group, and a preferable carbon number differs depending on the terminal group. When the terminal is a vinyl group, a preferable carbon number is 2 to 8, and is more preferably 2. When the terminal is an epoxy group, a glycidyloxy group or an epoxycyclohexyl group is preferable as a terminal group including the epoxy group, a linking group with a structure having an alkylene group having 2 to 5 carbon atoms (where the number of carbon atoms of R¹ as a whole is 10 or less) is preferable as a linking group which bonds the terminal group and the silicon atom, and the linking group is particularly preferably an ethylene group or a propylene group.

When the R¹ has a terminal group other than the vinyl group or the epoxy group, a linking group with a structure having an alkylene group having 2 to 5 carbon atoms (where the number of carbon atoms of R¹ as a whole is 10 or less) is preferable as a linking group which bonds the terminal group and the silicon atom, and the linking group is particularly preferably an ethylene group or a propylene group. When the R¹ has a chlorine atom at its terminal, the number of chlorine atom is preferably one, and as the R¹, a 2-chloroethyl group, or a 3-chloropropyl group is preferable.

In the compound (1), the group positioned at the terminal of the R¹ (which is also referred to as “R^{T1} group”, hereinafter) corresponds to the functional group, with the exception of the amino group, having the reactivity with respect to the (A) component. Therefore, the R¹ is appropriately selected depending on the kind of the (A) component.

Hereinafter, description will be made by setting the compound (1) having the epoxy group and/or the group having the reactivity with respect to the epoxy group and preferably used as the (B) silane-based coupling agent, when the (A) component is the raw material component of the first cured epoxy resin, for example, the first polyepoxide component, and the first catalyst type curing agent and/or the first polyaddition type curing agent, as a compound (1a).

The R^{T1} group of the compound (1a) is a functional group having reactivity with respect to the epoxy group possessed by the first polyepoxide component, a functional group which performs (self) polymerization reaction on the epoxy group, or a functional group which exhibits interaction with respect to the epoxy group or a ring-opened epoxy group, and is, concretely, the epoxy group or a group, with the exception of the amino group, having reactivity with respect to the epoxy group. In this case, as the R^{T1} group, an epoxy group, an isocyanate group, a mercapto group, a carboxy group, or a phenol group is preferable, and the epoxy group is particularly preferable.

Regarding the compound (1a) used as the (B) silane-based coupling agent in the base layer forming composition, one kind thereof may be used independently, or two kinds or more thereof may be used in combination. When one kind of the compound (1a) is used, the compound (1a) having the epoxy group as the R^{T1} group is preferable. When two kinds or more of the compounds (1a) are used, at least one kind thereof is preferably the compound (1a) whose R^{T1} group is the epoxy group.

As the compound (1a), concretely, 3-glycidoxypropyltrimethoxysilane, 3-glycidoxypropyltriethoxysilane, 3-glycidoxypropylmethyldiethoxysilane, 3-methacryloxypropylmethyldimethoxysilane, 3-(meth)acryloxypropyltrimethoxysilane, 3-mercaptopropyltrimethoxysilane, and the like are preferable.

When the (A) component is the raw material component of the first polyurethane resin, the isocyanate group or the like is preferable as the R^{T1} group possessed by the compound (1). When the (A) component is the raw material component of the first cross-linked acrylic resin, a group same as the cross-linkable group, the functional group, or the like possessed by the raw material component is preferable as the R^{T1} group possessed by the compound (1).

The content of the (B) silane-based coupling agent in the base layer forming composition is 60 to 200 parts by mass, preferably 60 to 150 parts by mass, and more preferably 65 to 100 parts by mass with respect to 100 parts by mass of the (A) component.

(C) Tetraalkoxysilane and/or Polymer Thereof

The base layer forming composition contains the (C) tetraalkoxysilane and the like by a ratio of 15 to 50 parts by mass with respect to 100 parts by mass of the (A) component. The content of the (C) tetraalkoxysilane and the like in the base layer forming composition is preferably 15 to 40 parts by mass, and more preferably 15 to 25 parts by mass, by oxide conversion, with respect to 100 parts by mass of the (A) component.

In the base layer forming composition, by setting the content of the (B) component to fall within the above-described range, and in addition to that, by setting the range of the content of the (C) tetraalkoxysilane and the like to the above-described range, the obtained base material has a structure resistant to the expansion as a whole, and it becomes possible to form a base layer having good moisture resistance and chemical resistance, and having a moderate water absorbing property as described above. Further, this makes it possible to increase the durability as the antifogging film.

Further, since the base layer forming composition contains the (C) tetraalkoxysilane and the like, reaction points between the base layer, and the substrate and the water absorbing layer increase, which further improves adhesiveness, resulting in that weather resistance of the obtained base layer can be increased. Further, when the base layer forming composition contains the (C) tetraalkoxysilane and the like, viscosity of the base layer forming composition decreases, resulting in that it becomes possible to more uniformly carry out the cross-linking reaction by the (A) raw material component of the first cured resin.

Here, generally, if the above-described amount of tetraalkoxysilane and the like is compounded in the composition containing the raw material component of the cured resin and the other reactive component such as the base layer forming composition, the gelation of the tetraalkoxysilane and the like is sometimes facilitated due to actions of the reactive groups possessed by the raw material component of the cured resin and the other reactive component.

In the present invention, by configuring such that the (B) silane-based coupling agent contained in the base layer forming composition has no reactive groups which facilitate the gelation of the (C) tetraalkoxysilane and the like, and preferably, by controlling the content of the reactive groups which facilitate the gelation of the (C) tetraalkoxysilane and the like regarding the (A) raw material component of the first cured resin as well, the gelation of the (C) tetraalkoxysilane and the like is suppressed. Accordingly, the pot life in the base layer forming composition is sufficiently long, and no influence is exerted on the productivity of the antifogging article.

As the tetraalkoxysilane used in the present invention, tetramethoxysilane and tetraethoxysilane are more preferable. One kind of them may be used independently, or the both two kinds may be used in combination.

As the polymer of tetraalkoxysilane, methyl silicate being a polymer of tetramethoxysilane, and ethyl silicate being a polymer of tetraethoxysilane are preferable, and methyl silicate whose average degree of polymerization is 2 to 10, and ethyl silicate whose average degree of polymerization is 2 to 10, are more preferable. They may be compounded in the base layer forming composition as a mixture of the tetraalkoxysilane and the polymer thereof.

(Base Layer Forming Composition)

The base layer in the antifogging film of the antifogging article of the present invention is a layer made of the base material obtained by using the base layer forming composition containing the above-described (A) to (C) reactive components and making the composition undergo reaction. The base layer forming composition normally contains a (D) solvent, in addition to the (A) to (C) components. Further, it is preferable that the base layer forming composition contains a catalyst of acid, alkali or the like, in order to facilitate the reaction of the (C) tetraalkoxysilane and the like.

Normally, the reaction using the base layer forming composition for obtaining the base material is conducted after applying the base layer forming composition on an application surface (on the substrate). Here, when the base layer forming composition contains the (D) solvent as described above, the (A) to (C) reactive components contained in the base layer forming composition may be reacted in advance to a certain extent in the composition before it is applied on the application surface (which is also referred to as “preliminary reaction”, hereinafter), and thereafter it may be applied on the application surface, dried, and subsequently further reacted.

As described above, when the (A) to (C) reactive components are subjected to the preliminary reaction in the (D) solvent as the base layer forming composition, the reaction temperature is preferably set to 25° C. or more, because the curing reaction proceeds securely. The degree of the preliminary reaction is set to a degree at which the reaction product is dissolved in the (D) solvent.

Further, the preliminary reaction may be conducted separately in two stages. Concretely, the preliminary reaction in the first stage in which the composition containing the (A) raw material component of the first cured resin, the (B) silane-based coupling agent, and the (D) solvent, is heated and stirred to be reacted is performed, and thereafter, the (C) tetraalkoxysilane and the like and preferably the acid catalyst or the alkaline catalyst are added to the resultant of the preliminary reaction in the first stage, to thereby perform the preliminary reaction in the second stage mainly as a partial hydrolysis and condensation reaction of the (C) tetraalkoxysilane and the like.

The preliminary reaction in the first stage depends on curing conditions of the first cured resin. When the first polyepoxide component, and the first catalyst type curing agent and/or the first polyaddition type curing agent are used as the (A) component, the preliminary reaction in the first stage is preferably performed at about 70 to 150° C. for 0.5 to 6 hours. The preliminary reaction in the second stage is preferably performed at 20 to 60° C. for 0.5 to 6 hours.

As the acid catalyst used for the partial hydrolysis and condensation reaction of the (C) tetraalkoxysilane and the like, there can be cited hydrochloric acid, nitric acid, acetic acid, sulfuric acid, phosphoric acid, sulfonic acid, methanesulfonic acid, paratoluenesulfonic acid, and the like. As the alkaline catalyst, there can be cited sodium hydroxide, potassium hydroxide, ammonia, and the like. A content of the catalyst in the base layer forming composition is preferably 0.1 to 5 parts by mass with respect to 100 parts by mass of the (C) tetraalkoxysilane and the like.

Note that since the partial hydrolysis and condensation reaction requires water, the base layer forming composition may also contain water. A content of water in the base layer forming composition is preferably 1 to 500 parts by mass with respect to 100 parts by mass of the (C) tetraalkoxysilane and the like. However, even if the base layer forming composition does not contain water, it is also possible to cause the partial hydrolysis and condensation reaction by utilizing moisture in an atmosphere.

(D) Solvent

The solvent used for the base layer forming composition is not particularly limited as long as it is a solvent having good solubility with respect to the solid content contained in the composition, and is also a solvent inert to these compounded components, and concretely, alcohols, acetic esters, ethers, ketones, water, and the like can be cited. It is preferable to use ethanol, 2-propanol, 1-propanol, acetone, butyl acetate, methyl ethyl ketone, propylene glycol monomethyl ether, and the like.

Only one kind of these solvents may be used, or two kinds or more of them may be used in combination. Further, the various components contained in the base layer forming composition are sometimes prepared as a mixture with a solvent used when manufacturing the respective components. In such a case, the solvent contained in this mixture may be used as it is as the solvent in the base layer forming composition, and in addition to that, the same or different kind of solvent may be further added to the base layer forming composition.

Further, an amount of the solvent in the base layer forming composition is preferably 200 to 950 parts by mass, and more preferably 400 to 950 parts by mass with respect to 100 parts by mass of the total mass of the whole solid content in the composition.

Here, regarding the contents of the first polyepoxide component, and the first catalyst type curing agent and/or the first polyaddition type curing agent as the (A) raw material component of the first cured epoxy resin in the base layer forming composition when the first cured epoxy resin is used as the first cured resin, the content of the first polyepoxide component is preferably 1 to 15 mass % with respect to the total amount of the composition, the content of the first catalyst type curing agent is preferably 0.01 to 1 mass % with respect to the total amount of the composition, and the content of the first polyaddition type curing agent is preferably 0.1 to 15 mass % with respect to the total amount of the composition. Note that also in the case where the first catalyst type curing agent and the first polyaddition type curing agent are used in combination, the contents of the both curing agents can be set to contents similar to the above.

Further, regarding the content (mass %) of each of the (B), (C) components with respect to the total amount of the composition, the content of the (B) silane-based coupling agent is preferably 0.1 to 15 mass %, and the content of the (C) tetraalkoxysilane and the like is preferably 0.01 to 5 mass % by oxide conversion, while securing the above-described content ratio with the (A) component. Further, the content of the solvent with respect to the total amount of the composition is preferably 50 to 95 mass %.

(Other Components)

Further, the base layer forming composition may also contain functional additives such as a filler, an antioxidant, an ultraviolet absorbent, an infrared absorbent, a light stabilizer, and the like according to need, other than the above-described respective components and solvent. Further, in order to improve a film formability of the base layer forming composition, it is possible to add a leveling agent, a defoamer, a viscosity modifier, or the like to the base layer forming composition.

<Filler>

The base layer Miming composition may also further contain the filler as an arbitrary component. When the filler is contained, mechanical strength, heat resistance, and bleedout resistance of the formed base layer can be increased, and further, cure contraction of a resin at a time of curing reaction can be decreased. As such a filler, a filler made of a metal oxide is preferable. As the metal oxide, for example, there can be cited silica, alumina, titania, and zirconia, and out of the above, silica is preferable. One kind of them may be used independently, or two kinds or more of them may be used in combination.

The filler contained in the base layer forming composition is preferably particulate. An average primary particle diameter of the filler is preferably 300 nm or less, more preferably 100 nm or less, and particularly preferably 50 nm or less. When the average primary particle diameter is set to 300 nm or less, a tendency to aggregate among particles in the composition containing the filler is not enhanced, and sedimentation of particles can be avoided. Further, when a base layer is formed of a composition containing the filler, generation of fogging due to scattering (haze) can be suppressed, and thus the above-described particle diameter is preferably employed in terms of maintaining transparency. Note that although a lower limit of the average primary particle diameter is not particularly limited, it is possible to use a particle of about 2 nm, which can be manufactured by the current technique. Here, the average primary particle diameter of particles refers to one measured from an observation image obtained by a transmission electron microscope.

Further, a content of the filler is preferably 0.5 to 25 parts by mass, and more preferably 1 to 20 parts by mass with respect to 100 parts by mass of the (A) raw material component of the first cured resin. When the content of the filler with respect to 100 parts by mass of the (A) raw material component of the first cured resin is set to 0.5 parts by mass or more, it is easy to suppress decrease in effect of decreasing cure contraction in the base material. Further, when the content of the filler with respect to 100 parts by mass of the (A) raw material component of the first cured resin is set to 25 parts by mass or less, the space for absorbing water can be adjusted moderately.

The silica used preferably as the filler, more preferably silica particles can be contained in the base layer forming composition as colloidal silica dispersed in water or an organic solvent such as methanol, ethanol, 2-propanol, methyl ethyl ketone, propylene glycol monomethyl ether, or butyl acetate. As the colloidal silica, there are silica hydrosol dispersed in water, and organo silica sol in which water is substituted by organic solvent. When these are contained in the base layer forming composition, it is preferable to use organo silica sol in which an organic solvent similar to the organic solvent used preferably in this composition is used as a dispersion medium.

As such organo silica sol, a commercial product can be used. As the commercial product, for example, there can be cited organo silica sol IPA-ST (product name, manufactured by Nissan Chemical Industries Ltd.) in which silica particles having a particle diameter of 10 to 20 nm are dispersed in 2-propanol by the ratio of 30 mass % as the content of SiO₂ with respect to the total amount of organo silica sol, organo silica sol NBAC-ST (product name, manufactured by Nissan Chemical Industries Ltd.) in which the organic solvent of the organo silica sol IPA-ST is changed from the 2-propanol to butyl acetate, organo silica sol MEK-ST (product name, manufactured by Nissan Chemical Industries Ltd.) in which the organic solvent of the organo silica sol IPA-ST is changed from the 2-propanol to methyl ethyl ketone, and the like. Note that when the colloidal silica is used as the silica particles, the amount of solvent contained in the base layer forming composition is appropriately adjusted as an amount including the solvent contained in the colloidal silica.

<Antioxidant>

The base layer forming composition preferably contains the antioxidant as an arbitrary component for increasing weather resistance of the obtained base layer. When the base material constituting the base layer is exposed to heat or light to be oxidized and deteriorated, stress accumulation easily occurs in the base layer, which easily causes peeling of the antifogging film. By adding the antioxidant, it becomes possible to suppress such a phenomenon. As the antioxidant, a phenolic antioxidant of a type of suppressing oxidation of resin by capturing and decomposing peroxy radical, a sulfur antioxidant or a phosphorus antioxidant which is a type of suppressing oxidation of resin by decomposing peroxide, and the like can be cited, but, in the present invention, it is preferable to use the phenolic antioxidant.

As the phenolic antioxidant, the following phenolic antioxidants contained in the cured resin such as the cured epoxy resin, the polyurethane resin, or the cross-linked acrylic resin, normally, can be used without any particular limitation. One kind of them may be used independently, or two kinds or more of them may be used in combination.

As a commercial product of the phenolic antioxidant, there can be cited IRGANOX 1010, IRGANOX 1035, IRGANOX 1076, IRGANOX 1135 (product names, manufactured by BASF), ADK STAB AO-30, ADK STAB AO-40, ADK STAB AO-50, ADK STAB AO-60, ADK STAB AO-70, ADK STAB AO-80, ADK STAB AO-90, and ADK STAB A-611 (product names, manufactured by ADEKA CORPORATION), Sumilizer GA-80, Sumilizer MDP-S, Sumilizer BBM-S, Sumilizer GM, Sumilizer GS(F), and Sumilizer GP (product names, manufactured by Sumitomo Chemical Industry Company Limited), and the like.

Further, an amount of the antioxidant contained in the base layer forming composition is preferably 0.1 to 1.0 parts by mass, and more preferably 0.2 to 0.8 parts by mass with respect to 100 parts by mass of the (A) raw material component of the first cured resin.

<Ultraviolet Absorbent>

The base layer forming composition may also contain the ultraviolet absorbent as an arbitrary component for increasing weather resistance, particularly resistance to ultraviolet rays, of the obtained base layer. As the ultraviolet absorbent, there can be cited conventionally publicly-known ultraviolet absorbents, concretely, a benzophenone-based compound, a triazine-based compound, a benzotriazole-based compound, and the like.

As the benzotriazole-based ultraviolet absorbent, 2-[5-chloro(2H)-benzotriazole-2-yl]-4-methyl-6-(tert-butyl) phenol, or the like is used. As the triazine-based ultraviolet absorbent, 2-(2-hydroxy-4-[1-octylcarbonylethoxy] phenyl)-4,6-bis(4-phenyl phenyl)-1,3,5-triazine, TINUVIN 400 (product name, manufactured by BASF), or the like is used. As the benzophenone-based ultraviolet absorbent, preferably, 2,2′,4,4′-tetrahydroxybenzophenone or the like is used.

In the present invention, one kind of these ultraviolet absorbents can be used independently, or two kinds or more of them can be used in combination. Further, among these ultraviolet absorbents, in the base layer forming composition used in the present invention, the benzophenone-based ultraviolet absorbent containing a hydroxyl group or the triazine-based ultraviolet absorbent containing a hydroxyl group as exemplified above is preferably used, since solubility to solvent and absorption wavelength range are desirable.

A content of the ultraviolet absorbent in the base layer forming composition is preferably 0.1 to 1.0 parts by mass, and more preferably 0.2 to 0.8 parts by mass with respect to 100 parts by mass of the (A) raw material component of the first cured resin, from a point that the base layer formed by using this does not impair the effects of the present invention and also has sufficient ultraviolet resistance.

<Infrared Absorbent>

The base layer forming composition may also contain the infrared absorbent as an arbitrary component in order to give a heat insulating effect by shielding against infrared rays, to the obtained base layer. As the infrared absorbent, an infrared absorbent made of inorganic compound particles, an infrared absorbent made of an organic dye, and the like can be cited.

Among the inorganic compound particles used as the infrared absorbent, in the present invention, tin-doped indium oxide (ITO) particles, antimony-doped tin oxide (ATO) particles, composite tungsten oxide, lanthanum hexaboride (LaB₆), and the like are preferable. In the present invention, the ITO particles are preferably used in terms of transmittance loss and environmental safety. One kind of them may be used independently, or two kinds or more of them may be used in combination.

A content of the infrared absorbent in the base layer forming composition is preferably 0.1 to 20 parts by mass, and more preferably 0.2 to 15 parts by mass with respect to 100 parts by mass of the (A) raw material component of the first cured resin, from a point that the base layer formed by using this does not impair the effects of the present invention and also has a heat insulating effect by sufficient shielding against infrared rays.

Note that when the base layer forming composition contains the inorganic compound particles as the infrared absorbent, the inorganic compound particles exhibit the function as the filler, in addition to the function thereof. Therefore, in this case, it is possible to decrease the content of the filler by the content of the inorganic compound particles.

<Light Stabilizer>

The base layer forming composition may also contain the light stabilizer as an arbitrary component in order to give light stability to the obtained base layer. As the light stabilizer, hindered amines; nickel complex such as nickel bis(octyl phenyl) sulfide, nickel complex-3,5-di-tert-butyl-4-hydroxy benzyl phosphoric acid monoethylate, nickel dibutyl dithiocarbamate, and the like can be cited. In the present invention, these light stabilizers can be used independently or in a combination of two or more of them.

Among them, as the light stabilizer used in the present invention, the hindered amines are preferable, and a hindered amine-based light stabilizer in which an amine portion is capped with an alkyl group or an alkoxy group, is preferable. As an example of commercial product, bis-(1,2,2,6,6-pentamethyl-4-piperidyl) sebacate (as a commercial product, ADK STAB LA-72 (product name, manufactured by ADEKA CORPORATION)) can be exemplified.

A content of the light stabilizer in the base layer forming composition is preferably 0.1 to 1.0 parts by mass, and more preferably 0.2 to 0.8 parts by mass with respect to 100 parts by mass of the (A) raw material component of the first cured resin, from a point that the base layer formed by using this does not impair the effects of the present invention and also has sufficient light stability.

As the additive such as the leveling agent, the defoamer, or the viscosity modifier contained according to need in the base layer forming composition, normally, each additive contained in the cured resin such as the cured epoxy resin, the polyurethane resin, or the cross-linked acrylic resin can be used without particular limitation. One kind of them may be used independently, or two kinds or more of them may be used in combination.

The content of each additive in the base layer forming composition can be set to, as for each component, 0.001 to 10 parts by mass with respect to 100 parts by mass of the (A) raw material component of the first cured resin.

(Base Layer)

The base layer in the antifogging article of the present invention is a layer formed by using the base layer forming composition. The base layer is formed by a base material obtained in a manner that the reactive components of (A) to (C) contained in the base layer forming composition undergo reaction, or when an additional reactive component is further contained, the reactive components of (A) to (C) and the additional reactive component undergo reaction, to take a non-reactive component contained in the composition therein. Since the base layer is constituted of such a base material, the base layer is a layer having a water absorbing property lower than that of the water absorbing layer, having sufficiently secured adhesiveness with the substrate and with the water absorbing layer, and having excellent peeling resistance by being provided with chemical resistance such that expansion due to acid moisture is suppressed. Note that forming conditions of the base layer using the base layer forming composition will be described in a manufacturing method to be described later.

[2-2] Water Absorbing Layer

The water absorbing layer constituting the antifogging film according to the embodiment of the present invention being a layer formed on the base layer, namely, on a side of the base layer opposite to the substrate side, is a layer made of a water absorbing material having a water absorbing property higher than that of the base material constituting the base layer, thereby securing an excellent water absorbing property of the antifogging film.

The saturated water absorption amount measured by the method described for the base layer of the water absorbing material constituting the water absorbing layer is preferably 50 mg/cm³ or more, more preferably 70 mg/cm³ or more, and particularly preferably 100 mg/cm³ or more. From a viewpoint of sufficiently securing the antifogging property in the antifogging film, the saturated water absorption amount of the water absorbing material constituting the water absorbing layer is preferably set to the above-described value. On the other hand, from a viewpoint of preventing decrease in durability of the antifogging film, the saturated water absorption amount of the water absorbing material constituting the water absorbing layer is preferably 900 mg/cm³ or less, and more preferably 500 mg/cm³ or less.

When the water absorbing property of the water absorbing layer constituting the antifogging film provided to the antifogging article of the present invention is represented by using the water absorbing and antifogging property described for the base layer as an index, the water absorbing and antifogging property of the water absorbing layer is preferably 50 seconds or more, more preferably 60 seconds or more, and particularly preferably 70 seconds or more.

From a relation between the saturated water absorption amount of the water absorbing material constituting the water absorbing layer and the water absorbing and antifogging property of the water absorbing layer, a film thickness of the water absorbing layer of the antifogging article of the present invention is preferably 5 μm or more, and more preferably 10 μm or more. This makes it easy to secure a high water absorbing property as the entire antifogging film. On the other hand, from a viewpoint of preventing decrease in durability of the antifogging film, the film thickness of the water absorbing layer is preferably 30 μm or less, and more preferably 25 μm or less. Here, the antifogging performance required for the antifogging article differs depending on the application, so that the design of the water absorbing layer may be changed appropriately according to the base layer in line with demanded performance.

A water absorbing material constituting the water absorbing layer is obtained by using a water absorbing layer forming composition containing a raw material component of a second cured resin selected from a second cured epoxy resin, a second polyurethane resin, and a second cross-linked acrylic resin. In other words, the water absorbing layer is formed by using the water absorbing layer forming composition.

The water absorbing material may be constituted only of the second cured resin, and it may also contain a component other than the second cured resin, within a range that does not impair the effects of the present invention. The water absorbing layer forming composition contains the raw material component of the second cured resin as a solid component, and arbitrarily contains a solid component other than the raw material component. The solid component other than the raw material component of the second cured resin may be a reactive component, for example, a component having reactivity with respect to the raw material component of the second cured resin, and it may also be a non-reactive component.

(Raw Material Component of Second Cured Resin)

The water absorbing layer forming composition contains the raw material component of the second cured resin. As the second cured resin, there can be cited the second cured epoxy resin, the second polyurethane resin, the second cross-linked acrylic resin, and the like. Note that when a curable component and a curing agent related to the second cured resin are mentioned in the description hereinbelow, all of them will be referred to as “second . . . ”.

The second cured epoxy resin is obtained through reaction of a composition containing a second polyepoxide component and a second curing agent, for example. The second polyurethane resin is obtained through reaction of a composition containing second polyisocyanate and second polyol, for example. The second cross-linked acrylic resin is obtained through reaction of a composition containing a second cross-linkable (meth)acrylic polymer and a second acrylic resin curing agent, for example. The second cured epoxy resin is preferable as the second cured resin.

(Second Cured Epoxy Resin)

As the raw material component of the second cured epoxy resin, a combination of the second polyepoxide component being a second curable component and the second curing agent is preferable. As the second curing agent, a second polyaddition type curing agent is preferably used, and further, it is more preferable that the second polyaddition type curing agent and a second catalyst type curing agent are used in combination. Specifically, the second cured epoxy resin is preferably a resin having a structure in which second polyepoxides are cross-linked by the second polyaddition type curing agent, to be three dimensional, obtained through reaction between the second polyepoxide component and the second polyaddition type curing agent. Further, it is more preferable to employ a second cured epoxy resin obtained through reaction between the second polyepoxide component, and the second polyaddition type curing agent and the second catalyst type curing agent.

<Second Polyepoxide Component>

As the polyepoxide constituting the second polyepoxide component, polyepoxide having no aromatic ring, specifically, aliphatic/alicyclic polyepoxide is preferable, from a point that a high water absorbing property can be obtained in the obtained cured epoxy resin.

As the second polyepoxide component, the aliphatic polyepoxide is particularly preferable. As the aliphatic polyepoxide, concretely, there can be cited aliphatic glycidyl ether-based polyepoxide, aliphatic glycidyl ester-based polyepoxide, aliphatic glycidyl amine-based polyepoxide, and the like. Out of the above, the aliphatic glycidyl ether-based polyepoxide derived from aliphatic polyols is preferable as the second polyepoxide component. Note that it is possible to use a commercial product also for the polyepoxide constituting the second polyepoxide component, similarly to the polyepoxide constituting the first polyepoxide component.

A molecular weight of the polyepoxide constituting the second polyepoxide component is preferably 200 to 3000, more preferably 300 to 2000, and particularly preferably 300 to 1800, from a viewpoint of durability, external appearance, and the like. Further, although the number of epoxy groups per molecule of the second polyepoxide component is not particularly limited as long as it is two or more on average, it is preferably 2 to 10, more preferably 3 to 8, and still more preferably 3 to 7. Further, the epoxy equivalent of the polyepoxide is preferably 120 to 200, and more preferably 130 to 190.

As the second polyepoxide component, one kind of the polyepoxides may be used independently, or two kinds or more of them may be used in combination. In the present invention, it is preferable to set such that the second polyepoxide component is constituted only of at least two kinds of the aliphatic polyepoxides having the molecular weight of 800 to 3000.

There is a case where a cured epoxy resin obtained by using polyepoxide having a ring structure, particularly aromatic polyepoxide having an aromatic ring, for example, glycidyl ether-based polyepoxide derived from polyphenols, cannot obtain a sufficient water absorbing property in a water absorbing material constituting the water absorbing layer. This can be considered as a phenomenon that moisture cannot easily be taken into the three-dimensional network structure due to that the aromatic ring or the like is hard. On the other hand, when the aliphatic/alicyclic polyepoxide is used, the three-dimensional network structure possessed by the obtained cured epoxy resin has moderate flexibility, and further, a size of a space of the three-dimensional network structure can be adjusted to a moderate size by adjusting the molecular weight, so that it is conceivable that both of the moderately-adjusted water absorbing property and durability can be obtained.

As the second curing agent which is reacted with the second polyepoxide component, it is preferable to use the second polyaddition type curing agent. Further, it is more preferable that the second polyaddition type curing agent is used in combination with the second catalyst type curing agent.

<Second Polyaddition Type Curing Agent>

The second polyaddition type curing agent is a compound having two or more reactive groups which react with epoxy groups contained in the polyepoxide, and is not particularly limited as long as it is a curing agent of a type that undergoes polyaddition with polyepoxide by reaction.

As the reactive group which reacts with the epoxy group in the second polyaddition type curing agent, there can be cited an amino group containing active hydrogen, a carboxy group, a thiol group, and the like. Specifically, as the second polyaddition type curing agent, the amino compound having the active hydrogen is preferably used. In the present invention, polyamines or polycarboxylic anhydrides are preferably used as the compound having two or more reacting groups as described above. As the second polyaddition type curing agent, one kind of these may be used independently, or two kinds or more of these may be used in combination.

It is preferable that the second polyaddition type curing agent being one of the raw material component of the second cured epoxy resin is also a compound having no aromatic ring, from a viewpoint that a high water absorbing property can be obtained. Therefore, the second polyaddition type curing agent is preferably polyamines or polycarboxylic anhydrides having no aromatic ring, and is particularly preferably the polyamines having no aromatic ring.

As the polyamines having no aromatic ring, an aliphatic polyamine compound and an alicyclic polyamine compound can be cited. As these polyamines, concretely, there can be cited ethylene diamine, triethylene diamine, triethylenetetramine, tetraethylenepentamine, hexamethylene diamine, polyoxyalkylene polyamine, isophoronediamine, menthene diamine, 3,9-bis(3-aminopropyl)-2,4,8,10-tetraoxaspiro(5,5) undecane, and the like.

As the polycarboxylic anhydrides having no aromatic ring, there can be cited, for example, a succinic anhydride, and the like.

It is also possible to use commercial products for the second polyaddition type curing agent. As such commercial products, concretely, there can be cited Jeffamine T-403 (produce name, manufactured by Huntsman, Molecular weight (Mw): 390) or the like as the polyoxyalkylene triamine, and Polythiol QE340M (product name, manufactured by Toray Fine Chemicals Co, Ltd.) or the like as the polyether polythiol.

Regarding the content ratio of the second polyepoxide component and the second polyaddition type curing agent in the raw material component of the second cured epoxy resin, the equivalent ratio of the reactive groups of the second polyaddition type curing agent with respect to the epoxy groups derived from the second polyepoxide component is preferably a ratio of 0.6 to 1.2, and more preferably 0.7 to 1.0. If the equivalent ratio of the reactive groups of the second polyaddition type curing agent with respect to the epoxy groups derived from the second polyepoxide component is within the above-described range, it is possible to obtain a cured epoxy resin having a three-dimensional network structure which is moderately cross-linked so as to have the above-described water absorbing property without lowering durability such as wear resistance.

When the amino compound having active hydrogen is used as the second polyaddition type curing agent in the present invention, preferably, it is used so that the equivalent ratio of amine active hydrogen with respect to the epoxy groups derived from the second polyepoxide component becomes a ratio of 0.6 to 0.8. In a similar manner to the above, if the equivalent ratio of amine active hydrogen with respect to the epoxy groups is within the above range, it is possible to obtain a cured epoxy resin having a three-dimensional network structure which is moderately cross-linked so as to have the above-described water absorbing property without significantly changing into yellow.

When the second polyepoxide component and the second polyaddition type curing agent are used in combination at the time of obtaining the second cured epoxy resin used in the present invention, it is preferable to use the second catalyst type curing agent in addition to the second polyepoxide component and the second polyaddition type curing agent. By using the second catalyst type curing agent, an effect of accelerating the speed of cross-linking by the polyaddition reaction of the second polyepoxide component and the second polyaddition type curing agent, and an effect of reducing a defect occurring in a cross-linking portion formed by the second polyepoxide component and the second polyaddition type curing agent can be obtained. As one example of the defect of the cross-linking portion, there can be cited coloring of a cured epoxy resin due to deterioration of cross-linking portion by a heat load.

<Second Catalyst Type Curing Agent>

Further, the second cured epoxy resin used in the present invention may also be a cured epoxy resin obtained by making the second polyepoxide component undergo a cross-linking reaction under existence of the second catalyst type curing agent. As the second catalyst type curing agent, a catalyst type curing agent similar to the first catalyst type curing agent can be used without particular limitation. A preferable mode and use of a commercial product of the second catalyst type curing agent can be set in a similar manner to the first catalyst type curing agent.

When the second catalyst type curing agent is used in addition to the second polyaddition type curing agent, the use amount of the second catalyst type curing agent is preferably 1 to 20 parts by mass, more preferably 1 to 10 parts by mass, and particularly preferably 1 to 7 parts by mass with respect to 100 parts by mass of the second polyepoxide component. When the use amount of the second catalyst type curing agent with respect to 100 parts by mass of the second polyepoxide component is set to 1 part by mass or more, the reaction proceeds sufficiently, and sufficient water absorbing property and durability can be realized in the obtained second cured epoxy resin. Further, when the use amount of the second catalyst type curing agent with respect to 100 parts by mass of the second polyepoxide component is 20 parts by mass or less, it is possible to easily suppress occurrence of problem in external appearance such that residues of the second catalyst type curing agent exist in the obtained second cured epoxy resin so that color of the cured epoxy resin changes to yellow.

Note that when the second catalyst type curing agent is used in addition to the second polyaddition type curing agent, regarding the use ratio of the second polyaddition type curing agent with respect to the second polyepoxide component, the equivalent ratio of reactive groups of the second polyaddition type curing agent with respect to epoxy groups can be reduced by about 10 to 50% of 0.6 to 1.2 described above, at the time of using the second catalyst type curing agent by the above-described ratio.

Further, the second cured epoxy resin may also be a resin having a structure in which polyepoxides obtained through reaction between the second polyepoxide component and the second catalyst type curing agent are three-dimensionally polymerized, according to need. In such a case, as the second curing agent, the second catalyst type curing agent is normally used independently. When the second catalyst type curing agent is used independently as described above, the use amount thereof is preferably 1 to 20 parts by mass, and more preferably 1 to 7 parts by mass with respect to 100 parts by mass of the second polyepoxide component.

The above is the description regarding the case where the second cured epoxy resin is used as the second cured resin. Regarding the second cured resin other than the second cured epoxy resin such as, for example, the second polyurethane resin and the second cross-linked acrylic resin, it is also possible to cite, as a raw material component thereof, a combination of a curable component and a curing agent in the conventionally publicly-known cured resin used as a water absorbing layer in an antifogging film.

A content of the raw material component of the second cured resin in the water absorbing layer forming composition is preferably 50 to 95 mass %, and more preferably 60 to 90 mass % with respect to the total solid content. By setting the range of the content to the above-described range, it is possible to realize both of the water absorbing performance and the wear resistance.

(Water Absorbing Layer Forming Composition)

The water absorbing layer in the antifogging film of the antifogging article of the present invention is a layer made of the water absorbing material obtained by using the water absorbing layer forming composition containing the raw material component of the second cured resin described above and making the composition undergo reaction. The water absorbing layer forming composition normally contains a solvent, in addition to the raw material component of the second cured resin.

Normally, the reaction using the water absorbing layer forming composition for obtaining the water absorbing material is conducted after applying the water absorbing layer forming composition on an application surface (on the base layer). Here, when the water absorbing layer forming composition contains the solvent as described above, the reactive components of the raw material component of the second cured resin and the like contained in the water absorbing layer forming composition may be reacted in advance to a certain extent in the composition before it is applied on the application surface, and thereafter it may be applied on the application surface, dried, and subsequently further reacted.

As described above, when the reactive components of the raw material component of the second cured resin and the like are reacted in advance to a certain extent in the solvent as the water absorbing layer forming composition, the reaction temperature when the reaction is caused in advance is preferably set to 25° C. or more, because the curing reaction proceeds securely.

(Solvent)

As the solvent used for the water absorbing layer forming composition, a solvent similar to the solvent used for the base layer forming composition can be used. It is preferable to use ethanol, 2-propanol, 1-propanol, acetone, butyl acetate, methyl ethyl ketone, propylene glycol monomethyl ether, and the like.

Only one kind of these solvents may be used, or two kinds or more of them may be used in combination. Further, the various components contained in the water absorbing layer forming composition are sometimes prepared as a mixture with a solvent used when manufacturing the respective components. In such a case, the solvent contained in this mixture may be used as it is as the solvent in the water absorbing layer forming composition, and in addition to that, the same or different kind of solvent may be further added to the water absorbing layer forming composition.

Further, an amount of the solvent in the water absorbing layer forming composition is preferably 100 to 500 parts by mass, and more preferably 200 to 350 parts by mass with respect to 100 parts by mass of the total mass of the whole solid content in the composition.

Here, regarding the contents of the second polyepoxide component and the second curing agent in the water absorbing layer forming composition when the second cured resin is the second cured epoxy resin, the content of the second polyepoxide component is preferably 10 to 40 mass %, and more preferably 15 to 30 mass % with respect to the total amount of the composition. The content of the second curing agent in the water absorbing layer forming composition is as described above as the content of the second polyaddition type curing agent and the content of the second catalyst type curing agent with respect to the second polyepoxide component. Note that when the second polyaddition type curing agent and the second catalyst type curing agent are used in combination, a total amount of the contents of these curing agents is preferably 3 to 20 mass %, and more preferably 3 to 16 mass % with respect to the total amount of the composition.

When the second polyaddition type curing agent and the second catalyst type curing agent are used in combination in the second cured epoxy resin, a content ratio of these curing agents depends on the type of the curing agents to be used. For example, when the amine compound having active hydrogen as the second polyaddition type curing agent, and the imidazole compound as the second catalyst type curing agent are used in combination, it is preferable that the water absorbing layer forming composition contains the amine compound having active hydrogen by the ratio of 3 to 15 mass %, and the imidazole compound by the ratio of 0.1 to 1.0 mass %, with respect to the total amount of the composition. By setting such content ratios, advantages of both of the second polyaddition type curing agent and the second catalyst type curing agent can be exhibited effectively.

(Other Components)

The water absorbing layer forming composition may also contain reactive or non-reactive functional additives such as a coupling agent, a filler, an antioxidant, an ultraviolet absorbent, an infrared absorbent, and a light stabilizer, according to need, other than the above-described respective components and solvent. Further, the water absorbing layer forming composition can contain a leveling agent, a defoamer, a viscosity modifier, or the like in order to improve a film formability.

<Coupling Agent>

As a reactive additive among additives contained arbitrarily in the water absorbing layer forming composition, there can be cited a coupling agent having a functional group having reactivity with respect to a reactive group possessed by the raw material component of the second cured resin, and the like. In the water absorbing layer forming composition, the coupling agent is a component compounded for the purpose of improving adhesiveness between the water absorbing layer and the base layer, or adhesiveness between the water absorbing layer and a functional layer when the functional layer is stacked on the water absorbing layer according to need, and is one of components preferred to be compounded.

As the coupling agent to be used, a silane-based coupling agent is preferable. As the silane-based coupling agent contained in the water absorbing layer forming composition, a silane-based coupling agent having an amino group, for example, a compound corresponding to the aforementioned compound (1) in which the R^{T1} group is the amino group, is preferable when the second cured epoxy resin is used. Concretely, there can be cited 3-aminopropyltrimethoxysilane, 3-aminopropylmethyldimethoxysilane, N-(2-aminoethyl)-3-aminopropylmethyldimethoxysilane, N-(2-aminoethyl)-3-aminopropyltrimethoxysilane, and the like. One kind of these may be used independently, or two kinds or more of these may be used in combination.

There is no lower limit in the compounding amount of the coupling agent in the water absorbing layer forming composition, since the coupling agent is not an essential component. However, in order to sufficiently exhibit the effect of compounding the coupling agent, a mass ratio of the coupling agent is preferably 5 to 40 parts by mass, and more preferably 10 to 30 parts by mass with respect to 100 parts by mass of the total mass of the curable component and the curing agent being the raw material component of the second cured resin in the water absorbing layer forming composition. An upper limit of the content of the coupling agent is limited by physical properties and functions of the coupling agent. When the coupling agent is used for the purpose of improving adhesiveness of the water absorbing layer made of the water absorbing material obtained by using the water absorbing layer forming composition, the mass ratio of the coupling agent with respect to 100 parts by mass of the total mass of the curable component and the curing agent being the raw material component of the second cured resin, is preferably 40 parts by mass or less, and more preferably 30 parts by mass or less. By preventing the use amount of the coupling agent from becoming excessive, it is possible to prevent coloring of the water absorbing material containing the second cured resin due to oxidation when exposed to high temperature, or the like.

Note that, when the silane-based coupling agent is used, for example, the content of the coupling agent with respect to the total amount of the water absorbing layer forming composition is preferably 2 to 10 mass %, and more preferably 3 to 7 mass %.

Here, if a particularly preferable composition in the water absorbing layer forming composition containing the silane-based coupling agent when the second cured epoxy resin is used as the second cured resin is mentioned, there can be cited a composition which contains the second polyepoxide component of 15 to 40 mass %, the amine compound having active hydrogen of 3 to 15 mass %, the imidazole compound of 0.1 to 1.0 mass %, the silane-based coupling agent of 2 to 10 mass %, and the solvent of 50 to 75 mass % with respect to the total amount of the composition.

In this case, when the water absorbing layer forming composition contains a coupling agent having an amino group as the coupling agent, regarding the equivalent ratio of amine active hydrogen relative to the epoxy groups, an equivalent ratio relative to the epoxy groups contained in the second polyepoxide component is calculated together with amine active hydrogen in the second curing agent and amine active hydrogen contained in the coupling agent, and is made to fall within the above-described preferable range.

Similarly, when the water absorbing layer forming composition contains a coupling agent having an epoxy group as the coupling agent, regarding the equivalent ratio of amine active hydrogen relative to the epoxy groups, an equivalent ratio relative to the amine active hydrogen in the second curing agent is calculated together with the epoxy groups contained in the second polyepoxide component and the epoxy groups contained in the coupling agent, and is made to fall within the above-described preferable range.

Out of the other components arbitrarily contained in the water absorbing layer forming composition, the filler, the antioxidant, the ultraviolet absorbent, the infrared absorbent, the light stabilizer, the leveling agent, the defoamer, the viscosity modifier, and the like can be similarly set to the respective components arbitrarily contained in the base layer forming composition, including the preferable modes, the contents and the like.

(Water Absorbing Layer)

The water absorbing layer in the antifogging article of the present invention is a water absorbing layer constituted of the water absorbing material containing the second cured resin, for example, the second cured epoxy resin, the second polyurethane resin, or the second cross-linked acrylic resin having the three-dimensional network structure, obtained through reaction of the water absorbing layer forming composition containing the second polyepoxide component and the second curing agent, the composition containing the second polyol and the second polyisocyanate, or the composition containing the second cross-linkable (meth)acrylic polymer and the second acrylic resin curing agent, and having high water absorbing property as well as durability such as wear resistance because of the properties of the second cured resin described above. Note that the conditions of the reaction will be explained in a manufacturing method to be described later.

Further, the arbitrarily added reactive additive such as the silane-based coupling agent exists in the water absorbing material (water absorbing layer) in the form of coupling to a part of the three-dimensional network structure of this second cured resin, and moreover, non-reactive additives which are added arbitrarily besides that exist in the water absorbing material (water absorbing layer) in an evenly dispersed and contained state in the three-dimensional network structure of the second cured resin.

(Antifogging Film)

The antifogging film in the antifogging article of the present invention is formed on a surface of at least a part of the substrate. The surface on which the antifogging film is formed is appropriately selected according to its application. Normally, the antifogging film is formed on one of main surfaces of the substrate. The antifogging film has a configuration in which the base layer and the water absorbing layer are stacked in this order from the substrate side. By employing such a configuration, the antifogging article of the present invention has excellent antifogging property as well as excellent durability such as wear resistance, chemical resistance, and moisture resistance.

If the water absorbing property of the antifogging film in the antifogging article of the present invention is concretely presented, the saturated water absorption amount measured by the method described for the base layer is preferably 50 mg/cm³ or more, more preferably 70 mg/cm³ or more, and particularly preferably 100 mg/cm³ or more.

Further, the water absorbing property of the antifogging film in the antifogging article of the present invention can be set to, as the water absorbing and antifogging property measured by the method described for the base layer, 50 seconds or more, 60 seconds or more in a further preferable mode, or 70 seconds or more in a particularly preferable mode. Here, the antifogging performance required for the antifogging article differs depending on its application, so that the design of the antifogging film may be changed appropriately in line with the required performance. Note that a soda lime glass on which an antifogging process is not performed normally fogs by about 1 to 3 seconds in the above-described test.

Further, the antifogging film in the antifogging article of the present invention may further have various functional films according to need, at a position between the base layer and the water absorbing layer formed on the substrate or on the water absorbing layer, within a range that does not impair the effects of the present invention. As such a functional film, concretely, there can be cited an antifouling layer giving contamination resistance to the antifogging film, an ultraviolet shielding layer, an infrared absorbing layer, and the like.

<Manufacturing Method of Antifogging Article>

The antifogging film of the antifogging article of the present invention has a configuration having the base layer and the water absorbing layer stacked in this order on the substrate. Such an antifogging film can be obtained by a method in which, concretely, the base layer forming composition is applied on a substrate surface and reacted to form the base layer, and then the water absorbing layer forming composition is applied on a base layer surface and reacted to form the water absorbing layer.

Hereinafter, description will be made on the manufacturing method of the antifogging article of the present invention by citing a case where the first cured resin in the above-described base layer forming composition is the first cured epoxy resin, and the water absorbing layer forming composition contains the raw material component of the second cured epoxy resin, as an example.

The manufacturing method of the antifogging article of the present invention includes: (a) obtaining the base material by applying and reacting the base layer forming composition containing the above-described (A) to (C) components (where the (A) component is the raw material component of the first cured epoxy resin) and the (D) solvent on a substrate surface, to form the base layer made of the base material; and (b) applying and reacting the water absorbing layer forming composition containing the raw material component of the second cured epoxy resin and the solvent on a surface of the base layer, to form the water absorbing layer made of the water absorbing material containing the second cured epoxy resin.

The components contained in each of the base layer forming composition and the water absorbing layer forming composition are as described above, and the two kinds of compositions are obtained by mixing these components by an ordinary method. Note that it is also possible that in each of the base layer forming composition and the water absorbing layer forming composition, the reaction is proceeded in advance to a certain extent in the stage of the composition, as described above.

In the step (a), the method of applying the base layer forming composition obtained above on the application surface of the substrate to form the base layer on the substrate is not particularly limited, and there can be cited publicly-known methods such as flow coating, dip coating, spin coating, spray coating, flexo printing, screen printing, gravure printing, roll coating, meniscus coating, die coating, and wiping. The application thickness of the base layer forming composition is set to a thickness which makes the thickness of the base layer finally obtained by reaction of the reaction components in the composition fall within the above range.

After the base layer forming composition is applied on the substrate, the solvent is removed by drying according to need, and curing treatment is performed under conditions in accordance with the used reaction components to obtain the base material, thereby making the base layer made of the base material. As the conditions to remove the solvent by drying, concretely, 50 to 90° C., and 5 to 15 minutes can be cited. Further, as a reaction condition of the reaction components in the base layer forming composition, namely, the above-described (A) to (C) components, concretely, there can be cited heat treatment at about 70 to 150° C. for 1 to 60 minutes. Note that even when the drying is not performed in advance, normally, the drying is performed at the same time as the reaction. Further, when the light-curing resin of UV curing is used, a process such as performing UV irradiation of 100 to 500 mJ/cm² for 1 to 5 seconds with a UV curing apparatus or the like can be cited.

Here, in the manufacturing method of the present invention, it is preferable to perform the reaction of the base layer forming composition under a constant humidifying condition. By performing the reaction under the humidifying condition, in the reaction performed under the same temperature condition, the reaction time can be shortened when compared to the case where humidifying is not performed. Further, when the reaction time is the same, by performing humidifying, it becomes possible to sufficiently carry out the reaction even if the reaction temperature is set to a low temperature. In each of the cases, it is economically advantageous to perform the reaction under the humidifying condition. Moreover, by performing the reaction under the humidifying condition, the reaction can be performed uniformly through the entire layer, and dispersion in quality in the base layer can be suppressed.

As the humidifying condition, concretely, 40 to 80% RH can be cited, and, a condition of 50 to 80% RH is more preferable. If more preferable reaction conditions are presented together with temperature conditions, there can be cited reaction conditions of about 50 to 80% RH, 70 to 100° C., and 5 to 30 minutes. As further preferable conditions, there can be cited reaction conditions of about 50 to 80% RH, 80 to 100° C., and 10 to 30 minutes.

The method of applying the water absorbing layer forming composition in the step (b) on the surface of the base layer formed on the substrate by the step (a), can be similar to the application method of the base layer forming composition. The application thickness of the water absorbing layer forming composition is set to a thickness which makes the thickness of the water absorbing layer finally obtained by the reaction of the reaction components in the composition fall within the above range.

After the water absorbing layer forming composition is applied on the base layer, the solvent is removed by drying according to need, and curing treatment is performed under conditions in accordance with the used reaction components, thereby making the water absorbing layer constituted of the water absorbing material containing the second cured epoxy resin. As the conditions to remove the solvent by drying, concretely, 50 to 90° C., and 5 to 15 minutes can be cited. Further, as a reaction condition of the reaction components in the water absorbing layer forming composition, namely, the raw material component of the second cured epoxy resin, particularly the second polyepoxide component and the second polyaddition type curing agent under existence of the second catalyst type curing agent, concretely, there can be cited heat treatment at about 50 to 120° C. for 10 to 60 minutes. Note that even when the drying is not performed in advance, normally, the drying is performed at the same time as the reaction. Further, when the light-curing resin of UV curing is used, a process such as performing UV irradiation of 50 to 1000 mJ/cm² for 5 to 10 seconds with a UV curing apparatus or the like can be cited.

Here, in the manufacturing method of the present invention, it is preferable to perform the reaction of the water absorbing layer forming composition under a constant humidifying condition in a similar manner to the case of the base layer forming composition, based on the above reasons. As the humidifying condition, concretely, 40 to 80% RH can be cited, but, a condition of 50 to 80% RH is more preferable. If more preferable reaction conditions are presented together with temperature conditions, there can be cited reaction conditions of about 50 to 80% RH, 70 to 100° C., and 5 to 30 minutes. As further preferable conditions, there can be cited reaction conditions of about 50 to 80% RH, 80 to 100° C., and 10 to 30 minutes. By performing the step (a) and the step (b) in the above-described manner, the antifogging article of the present invention in which the antifogging film is formed on the substrate is obtained.

<Article for Transportation Apparatus>

The antifogging article of the present invention is used preferably in an application as an article for transportation apparatus. As the article for transportation apparatus, a body, a window glass (windshield, side glass, rear glass), a mirror, and the like of electric train, automobile, boat, aircraft, or the like can be preferably cited.

The article for transportation apparatus provided with the antifogging article having the antifogging film of the present invention includes the antifogging film which exhibits excellent antifogging property, so that adverse effects of fogging or the like induced by moisture can be eliminated. Further, the antifogging film also excels in durability, so that this antifogging property can be maintained even in a long-term use under various use conditions including outdoor use as the article for transportation apparatus, for example.

### EXAMPLES

Hereinafter, the present invention will be concretely described by citing examples, but, the present invention is not limited to these examples. Note that Examples 1 to 4, and Examples 9 to 12 are examples, and Examples 5 to 8, and Examples 13 to 16 are comparative examples.

Abbreviations and physical properties of compounds used in the examples and the comparative examples are summarized below. Note that Denacol is a product name of Nagase ChemteX Corporation.

### (A) Raw Material Component of Cured Epoxy Resin

### (1) Polyepoxide

(1-1) Sorbitol polyglycidyl ether
EX614B: Denacol EX-614B (Mw: 949, epoxy equivalent: 171)
   (1-2) Polyglycerol polyglycidyl ether
EX521: Denacol EX-521 (Mw: 1294, epoxy equivalent: 179)
   (1-3) Aliphatic polyglycidyl ether
EX1610: Denacol EX-1610 (Mw: 1130, epoxy equivalent: 165)
   (1-4) Bisphenol-A diglycidyl ether
jER828 (product name, manufactured by Mitsubishi Chemical Corporation, Mw: 340, epoxy equivalent: 190)

### (2) Polyaddition Type Curing Agent

T403: Jeffamine T403 (product name, manufactured by Huntsman, Mw: 390, amine active hydrogen equivalent: 78), polyoxyalkylene triamine

### (3) Catalyst Type Curing Agent

2MZ: 2-methylimidazole

### (B) Silane-Based Coupling Agent (Symbols of the Following Silane-Based Coupling Agents are Names of Products Manufactured by Shin-Etsu Chemical Co., Ltd.)

KBM403: 3-glycidoxypropyltrimethoxysilane
KBM903: 3-aminopropyltrimethoxysilane

### (C) Tetraalkoxysilane and the Like

TMOS: tetramethoxysilane (manufactured by Tokyo Chemical Industry Co., Ltd.)

(Non-Reactive Component)
A-611: ADK STAB A-611 (product name, manufactured by ADEKA CORPORATION), phenolic antioxidant
MEKST: MEK-ST (product name, manufactured by Nissan Chemical Industries Ltd.), organo silica sol in which silica particles having a particle diameter of 10 to 20 nm are dispersed in methyl ethyl ketone, SiO₂ content 30 mass %

### (Other Component)

BYK307: BYK307 (product name, manufactured by BYK-chemie), leveling agent

Evaluation of the antifogging article in each example was performed as follows.

### [Measurement of Film Thickness]

A cross-sectional image of the antifogging article was taken by a scanning electron microscope (S4300, manufactured by Hitachi, Ltd.), and film thicknesses of respective layers of the base layer and the water absorbing layer were measured. [Evaluation of antifogging property] The water absorbing and antifogging property in the antifogging film was measured by the above-described method. The antifogging performance required for the antifogging film differs depending on its application. In the present example, in practice, the water absorbing and antifogging property of 50 seconds or more is required, 60 seconds or more is preferable, and 70 seconds or more is further preferable.

### [Evaluation of Acid Resistance]

A 10 wt % aqueous solution of acetic acid (manufactured by JUNSEI CHEMICAL CO., LTD.) of 200 μL was dropped onto a surface of the antifogging film of the antifogging article by using a micropipette, the antifogging article was left for 24 hours at 23° C., and then the presence/absence of peeling of the antifogging film was evaluated. Note that the presence/absence of the peeling was checked visually. Hereinafter, a method similar to this was employed as a method of checking the presence/absence of peeling.

[Evaluation of Moisture Resistance (i)]

The antifogging article was put into a thermohygrostat under an environment of 50° C. and 95% RH for 500 hours, and the presence/absence of peeling of the antifogging film after 500 hours was evaluated.

[Evaluation of Moisture Resistance (ii)]

The antifogging article was put into a thermohygrostat under an environment of 80° C. and 95% RH for 500 hours, and the presence/absence of peeling of the antifogging film was evaluated according to the following criteria.

### (Criteria of Peeling Evaluation Regarding Moisture Resistance)

“S”: Peeling did not occur for 500 hours or longer.
“A”: Peeling occurred after lapse of 100 hours to 500 hours.
“B”: Peeling occurred within 100 hours.

[Evaluation of Heat Yellowing Resistance]

The antifogging article was put into a thermostat under an environment of 100° C. for 500 hours, and a change in degree of yellowness (ΔYI) before and after the article was put into the thermostat was measured by using a color-difference meter (SD6000, manufactured by NIPPON DENSHOKU INDUSTRIES CO., LTD.).

[Evaluation of Pot Life]

The base layer forming composition put into a glass container was stored under an environment of 25° C. and 70% RH, and evaluation was conducted visually based on the following evaluation criteria.
“A”: No change was observed in external appearance for 14 days or longer.
“B”: A change such as cloudiness, sedimentation, or gelation was observed within less than 14 days.

<1> Preparation of Base Layer Forming Composition

### Example 1

In a glass container in which a stirrer and a thermometer were set, 58.43 g of propylene glycol monomethyl ether (manufactured by DAISHIN CHEMICAL CO., LTD.), 2.99 g of 2-propanol (manufactured by JUNSEI CHEMICAL CO., LTD.), 6.16 g of sorbitol polyglycidyl ether (EX614B), 5.20 g of epoxysilane (KBM403), 3.35 g of tetramethoxysilane (manufactured by JUNSEI CHEMICAL CO., LTD.) 11.88 g of 0.1N nitric acid (manufactured by JUNSEI CHEMICAL CO., LTD.), and 0.04 g of leveling agent (BYK307) were put and stirred at 25° C. for 60 minutes, thereby obtaining a base layer forming composition (U-1). The composition and so on are presented in Table 1.

### Example 2

In a glass container in which a stirrer and a thermometer were set, 44.58 g of propylene glycol monomethyl ether (manufactured by DAISHIN CHEMICAL CO., LTD.), 4.98 g of 2-propanol (manufactured by JUNSEI CHEMICAL CO., LTD.), 4.40 g of sorbitol polyglycidyl ether (EX614B), 8.66 g of epoxysilane (KBM403), 5.58 g of tetramethoxysilane (manufactured by JUNSEI CHEMICAL CO., LTD.), 19.80 g of 0.1N nitric acid (manufactured by JUNSEI CHEMICAL CO., LTD.), and 0.04 g of leveling agent (BYK307) were put and stirred at 25° C. for 60 minutes, thereby obtaining a base layer forming composition (U-2). The composition and so on are presented in Table 1.

### Example 3

In a glass container in which a stirrer and a thermometer were set, 61.89 g of propylene glycol monomethyl ether (manufactured by DAISHIN CHEMICAL CO., LTD.), 2.49 g of 2-propanol (manufactured by JUNSEI CHEMICAL CO., LTD.), 6.60 g of sorbitol polyglycidyl ether (EX614B), 4.33 g of epoxysilane (KBM403), 2.79 g of tetramethoxysilane (manufactured by JUNSEI CHEMICAL CO., LTD.), 9.90 g of 0.1N nitric acid (manufactured by JUNSEI CHEMICAL CO., LTD.), and 0.04 g of leveling agent (BYK307) were put and stirred at 25° C. for 60 minutes, thereby obtaining a base layer forming composition (U-3). The composition and so on are presented in Table 1.

### Example 4

In a glass container in which a stirrer and a thermometer were set, 4.50 g of butyl acetate (manufactured by JUNSEI CHEMICAL CO., LTD.), 6.16 g of sorbitol polyglycidyl ether (EX614B), 5.20 g of epoxysilane (KBM403), 0.62 g of methyl-1,2,3,6-tetrahydrophthalic anhydride (isomer mixture) (manufactured by Wako Pure Chemical Industries, Ltd.) (with equivalent ratio of reactive groups with respect to epoxy groups in the first polyepoxide component of 0.1), and 0.08 g of 2-methylimidazole (manufactured by SHIKOKU CHEMICALS CORPORATION) were added while stirring, and stirred at 105° C. for four hours. Next, 56.80 g of propylene glycol monomethyl ether (manufactured by DAISHIN CHEMICAL CO., LTD.), 3.35 g of tetramethoxysilane (manufactured by JUNSEI CHEMICAL CO., LTD.), 11.88 g of 0.1N nitric acid (manufactured by JUNSEI CHEMICAL CO., LTD.), and 0.04 g of leveling agent (BYK307) were put and stirred at 25° C. for 60 minutes, thereby obtaining a base layer forming composition (U-4). The composition and so on are presented in Table 1.

### Example 5

In a glass container in which a stirrer and a thermometer were set, 37.65 g of propylene glycol monomethyl ether (manufactured by DAISHIN CHEMICAL CO., LTD.), 5.97 g of 2-propanol (manufactured by JUNSEI CHEMICAL CO., LTD.), 3.52 g of sorbitol polyglycidyl ether (EX614B), 10.40 g of epoxysilane (KBM403), 6.70 g of tetramethoxysilane (manufactured by JUNSEI CHEMICAL CO., LTD.), 23.76 g of 0. IN nitric acid (manufactured by JUNSEI CHEMICAL CO., LTD.), and 0.04 g of leveling agent (BYK307) were put and stirred at 25° C. for 60 minutes, thereby obtaining a base layer forming composition (U-5). The composition and so on are presented in Table 1.

### Example 6

In a glass container in which a stirrer and a thermometer were set, 65.35 g of propylene glycol monomethyl ether (manufactured by DAISHIN CHEMICAL CO., LTD.), 1.99 g of 2-propanol (manufactured by JUNSEI CHEMICAL CO., LTD.), 7.04 g of sorbitol polyglycidyl ether (EX614B), 3.47 g of epoxysilane (KBM403), 2.23 g of tetramethoxysilane (manufactured by JUNSEI CHEMICAL CO., LTD.), 7.92 g of 0.1N nitric acid (manufactured by JUNSEI CHEMICAL CO., LTD.), and 0.04 g of leveling agent (BYK307) were put and stirred at 25° C. for 60 minutes, thereby obtaining a base layer forming composition (U-6). The composition and so on are presented in Table 1.

### Example 7

In a glass container in which a stirrer and a thermometer were set, 72.28 g of propylene glycol monomethyl ether (manufactured by DAISHIN CHEMICAL CO., LTD.), 0.99 g of 2-propanol (manufactured by JUNSEI CHEMICAL CO., LTD.), 7.92 g of sorbitol polyglycidyl ether (EX614B), 1.73 g of epoxysilane (KBM403), 1.12 g of tetramethoxysilane (manufactured by JUNSEI CHEMICAL CO., LTD.), 3.96 g of 0.1N nitric acid (manufactured by JUNSEI CHEMICAL CO., LTD.), and 0.04 g of leveling agent (BYK307) were put and stirred at 25° C. for 60 minutes, thereby obtaining a base layer forming composition (U-7). The composition and so on are presented in Table 1.

### Example 8

In a glass container in which a stirrer and a thermometer were set, 6.00 g of propylene glycol monomethyl ether (manufactured by DAISHIN CHEMICAL CO., LTD.), 5.51 g of bisphenol-A diglycidyl ether (jER828), 1.59 g of polyoxyalkylene triamine (T403), and 0.78 g of aminosilane (KBM903) were put and stirred at 35° C. for 60 minutes. Next, 66.14 g of propylene glycol monomethyl ether (manufactured by DAISHIN CHEMICAL CO., LTD.), and 0.04 g of leveling agent (BYK307) were added, thereby obtaining a base layer forming composition (U-8). The composition and so on are presented in Table 1.

TABLE 1

| Example | | | | 1 | 2 | 3 | 4 | 5 | 6 | 7 | 8 |
|---|---|---|---|---|---|---|---|---|---|---|---|
| Abbreviation of base layer forming composition | | | | U-1 | U-2 | U-3 | U-4 | U-5 | U-6 | U-7 | U-8 |
| Compounding | (A) | First polyepoxide | EX614B | 7% | 5% | 8% | 7% | 4% | 8% | 9% | — |
| amount with | | component | jER828 | — | — | — | — | — | — | — | 7% |
| respect to | | First polyaddition | Methyl-1,2,3,6-tetrahydrophthalic | — | — | — | 0.7% | — | — | — | — |
| total amount of | | type curing agent | anhydride (isomer mixture) | | | | | | | | |
| composition | | | T403 | — | — | — | — | — | — | — | 2% |
| (mass %) | | First catalyst | 2MZ | — | — | — | 0.09% | — | — | — | — |
| | | type curing agent | | | | | | | | | |
| Content of raw material component of first cured | | | | 42% | 24% | 48% | 45% | 17% | 55% | 74% | 90% |
| resin with respect to total solid content (mass %) | | | | | | | | | | | |
| Parts by mass | (B) | Silane-based | KBM403 | 84 | 197 | 66 | 84 | 295 | 49 | 22 | — |
| with respect | | coupling agent | KBM903 | — | — | — | — | — | — | — | 14 |
| to 100 parts | (C) | Tetraalkoxy- | TMOS | 21 | 49 | 16 | 21 | 74 | 12 | 5 | — |
| by mass of | | silane/polymer | | | | | | | | | |
| (A) | | (oxide conversion) | | | | | | | | | |

| | | | | | | | | | |
|---|---|---|---|---|---|---|---|---|---|
| Evaluation | Pot life | A | A | A | A | A | A | A | B |

[Manufacturing of Water Absorbing Layer Forming Composition]

In a glass container in which a stirrer and a thermometer were set, 12.24 g of mixed alcohol (ethanol:2-propanol:1-propanol=88:4:8 (mass ratio), and Neoethanol PIP (product name), manufactured by DAISHIN CHEMICAL CO., LTD.), 9.80 g of aliphatic polyglycidyl ether (EX1610), 8.14 g of polyglycerol polyglycidyl ether (EX521), 6.44 g of organo silica sol (MEKST), 0.42 g of 2-methyl imidazole (manufactured by SHIKOKU CHEMICALS CORPORATION), 3.29 g of aminosilane (KBM 903), 3.20 g of polyoxyalkylene triamine (T403), and 0.14 g of antioxidant (A-611) were added while stirring, and stirred at 25° C. for one hour.

Next, 28.57 g of methyl ethyl ketone (manufactured by DAISHIN CHEMICAL CO., LTD.), 2.76 g of organo silica sol (MEKST), and 0.04 g of leveling agent (BYK307) were added while stirring, thereby obtaining a water absorbing layer forming composition T-1. The composition and so on are presented in Table 2. Note that in the field of amine active hydrogen/epoxy group in Table 2, the equivalent ratio of amine active hydrogen contained in aminosilane and the epoxy groups (amine active hydrogen/epoxy groups) is presented.

TABLE 2

| Abbreviation of water absorbing layer forming composition | | | T-1 |
|---|---|---|---|
| Content with respect to | Second polyepoxide | EX521 | 10.9% |
| total amount of | component (X) | EX1610 | 13.1% |
| composition (mass %) | | Total | 23.9% |
| | | amount | |
| | Second polyaddition | T403 | 4.3% |
| | type curing agent (Y) | | |
| | Second catalyst type | 2MZ | 0.6% |
| | curing agent (Z) | | |
| Content of raw material component of second cured resin with | | | 77.6% |
| respect to total solid content (mass %) | | | |
| Parts by mass with | Silane-based coupling | KBM903 | 15.3 |
| respect to 100 parts by | agent | | |
| mass of (X) + (Y) + (Z) | Filler | MEKST | 12.8 |
| | Antioxidant | A-611 | 0.65 |

| | |
|---|---|
| Amine active hydrogen/epoxy groups | 0.75 |

<3> Manufacturing and Evaluation of Antifogging Article

By using the respective compositions obtained in the above-described manufacturing example, the antifogging film was formed on each of the substrates as follows, and evaluation was performed by the above-described evaluation method. The obtained result is presented in Table 3.

### Examples 9 to 16

A dried clean soda lime glass substrate (water contact angle 3°, 200 mm×200 mm×2 mm thickness) whose surface was polished and cleaned with cerium oxide was used as the substrate, each of the base layer forming compositions U-1 to U-8 obtained above was applied as presented in Table 3 by flow coating on the surface of the glass substrate, and it was retained for 30 minutes in an electric furnace at 100° C. to form a base layer. Next, on the formed base layer surface, the water absorbing layer forming composition T-1 obtained above was applied as presented in Table 3 by flow coating, and it was retained for 30 minutes in the electric furnace at 100° C. to form a water absorbing layer, thereby obtaining an antifogging article having an antifogging film formed of the base layer and the water absorbing layer.

TABLE 3

| | Base layer | | Water absorbing layer | | Antifogging film | | | | | |
|---|---|---|---|---|---|---|---|---|---|---|
| | Abbrevi- | Film | Abbrevi- | Film | Film | Water absorbing | Acid | Moisture | | Heat |
| | ation of | thick- | ation of | thick- | thick- | and antifogging | resistance | resistance (i) | Moisture | yellowing |
| | compo- | ness | compo- | ness | ness | property | (presence/absence | (presence/absence | resistance | resistance |
| Example | sition | [μm] | sition | [μm] | [μm] | [Second] | of peeling) | of peeling) | (ii) | ΔYI |
| 9 | U-1 | 1.8 | T-1 | 17.5 | 19.3 | 95 | Absence | Absence | A | 1.3 |
| 10 | U-2 | 1.9 | | 18.6 | 20.5 | 92 | Absence | Absence | A | 1.2 |
| 11 | U-3 | 1.8 | | 17.6 | 19.4 | 96 | Absence | Absence | A | 1.3 |
| 12 | U-4 | 2.0 | | 18.2 | 20.2 | 100 | Absence | Absence | S | 1.3 |
| 13 | U-5 | 1.7 | | 18.5 | 20.2 | 95 | Absence | Presence | B | 1.4 |
| 14 | U-6 | 1.9 | | 18.2 | 20.1 | 91 | Presence | Absence | B | 1.3 |
| 15 | U-7 | 1.9 | | 17.8 | 19.7 | 90 | Presence | Presence | B | 1.5 |
| 16 | U-8 | 2.2 | | 18.0 | 20.2 | 89 | Presence | Absence | S | 3.5 |

An antifogging article of the present invention has excellent antifogging property as well as durability such as wear resistance, chemical resistance, and moisture resistance, so that it is effective as an antifogging glass for transportation apparatuses such as automobiles or for buildings. A base layer forming composition for obtaining the antifogging article of the present invention has a sufficiently long pot life, and thus good production efficiency of the antifogging article is provided.

What is claimed is:

1. An antifogging article having a substrate and an antifogging film on a surface of at least a part of the substrate, wherein:
the antifogging film has, in order from the substrate side, a base layer made of a base material with low water absorbing property, and a water absorbing layer made of a water absorbing material having a water absorbing property higher than that of the base material; and
the base material is obtained by using a base layer forming composition comprising the following (A) to (C) components:
(A) 100 parts by mass of a raw material component of a first cured resin;
(B) 60 to 200 parts by mass of a silane-based coupling agent having a functional group other than an amino group having reactivity with the (A) component and a hydrolyzable group; and
(C) 15 to 50 parts by mass, by oxide conversion, of tetraalkoxysilane and/or a polymer thereof.

2. The antifogging article according to claim 1, wherein a saturated water absorption amount of the water absorbing material is 50 mg/cm³ or more.

3. The antifogging article according to claim 1, wherein a saturated water absorption amount of the base material is 10 mg/cm³ or less.

4. The antifogging article according to claim 1, wherein the silane-based coupling agent is at least one selected from compounds represented by the following general formula (1),
R¹SiR²ₙX¹₃₋ₙ (1)
where R¹ indicates a monovalent organic group having 1 to 10 carbon atoms and an epoxy group, an acryloxy group, a methacryloxy group, a vinyl group, a mercapto group, an isocyanate group, an ureido group, or a chlorine atom at a terminal thereof, R² indicates a monovalent hydrocarbon group having 1 to 4 carbon atoms, n indicates an integer of 0 or 1, and X¹ indicates hydrolyzable groups which may be mutually the same or different, respectively.

5. The antifogging article according to claim 1, wherein the tetraalkoxysilane and/or the polymer thereof is at least one selected from the group consisting of tetramethoxysilane, tetraethoxysilane, methyl silicate having average degree of polymerization is 2 to 10, and ethyl silicate having average degree of polymerization is 2 to 10.

6. The antifogging article according to claim 1, wherein the first cured resin is a first cured epoxy resin, a first polyurethane resin, or a first cross-linked acrylic resin.

7. The antifogging article according to claim 1, wherein the first cured resin is a cured epoxy resin, the (A) component comprises a first polyepoxide component, and a first polyaddition type curing agent and/or a first catalyst type curing agent, and the functional group contained in the (B) component is an epoxy group and/or a group having reactivity with the epoxy group.

8. The antifogging article according to claim 7, wherein the first catalyst type curing agent comprises an imidazole compound, and the first polyaddition type curing agent comprises an acid anhydride.

9. The antifogging article according to claim 1, wherein the water absorbing material is obtained by using a water absorbing layer forming composition comprising a raw material component of a second cured resin selected from a second cured epoxy resin, a second polyurethane resin, and a second cross-linked acrylic resin.

10. The antifogging article according to claim 9, wherein the raw material component of the second cured epoxy resin comprises a second polyepoxide component, a second polyaddition type curing agent, and a second catalyst type curing agent.

11. The antifogging article according to claim 1, wherein a film thickness of the base layer is 1 to 8 μm, and a film thickness of the water absorbing layer is 5 to 30 μm.

12. The antifogging article according to claim 1, wherein the substrate is made of glass.

13. An article for transportation apparatus, comprising the antifogging article according to claim 1.

14. A base layer forming composition for obtaining the antifogging article according to claim 1, the base layer forming composition comprising: the (A) to (C) components; and a (D) solvent.

15. A manufacturing method of the antifogging article according to claim 1, the method comprising:
applying and curing the base layer forming composition on a substrate surface to form the base layer; and
forming the water absorbing layer made of the water absorbing material on a surface of the base layer.
